(19) United States
(12) Patent Application Publication
(10) Pub. No.: US 2026/0361547 A1
(43) Pub. Date: Nov. 12, 2026

(54) AGENT-ORCHESTRATION BRIDGE FOR RESOURCE-CONSTRAINED ELECTRONIC MESSAGE SURFACES

(71) Applicant: Benjamin Hopwood, Denver, CO (US)

(72) Inventor: Benjamin Hopwood, Denver, CO (US)

(73) Assignee: Agentic Solutions LLC, Denver, CO (US)

(21) Appl. No.: 19/669,709

(22) Filed: May 6, 2026

Related U.S. Application Data
(60) Provisional application No. 63/802,464, filed on May 8, 2025.

(51) Int. Cl. H04L 9/32; H04L 9/00

(52) U.S. Cl. CPC H04L 9/3236; H04L 9/50

(57) ABSTRACT

An agent-orchestration bridge resolves the protocol-constraint boundary between resource-constrained electronic message surfaces and agent-orchestration protocols whose payloads exceed the surfaces' byte ceilings, enabling autonomous software agents to conduct multi-turn workflows through channels previously inaccessible to agent protocols. The bridge maintains stateful session context across the boundary so that agent memory, tool state, and negotiation history persist across conversational turns. Returned agent data is subject to byte-budget enforcement through relevance-based selection with placeholder substitution for excluded elements. A tool-proxy module invokes external tools with per-invocation audit logging. An economic settlement module calculates usage and success fees within a tamper-evident audit chain. Agent identity credentials are bidirectionally mapped across the boundary to preserve trust chains. A cryptographic hash chain verifies transformation integrity across the constraint boundary.

### CROSS-REFERENCE TO RELATED APPLICATIONS

This application claims the benefit of priority under 35 U.S.C. § 119(e) to U.S. Provisional Patent Application No. 63/802,464, filed May 8, 2025, entitled “Architecture for Multi-Turn Conversational Agents and Data Interchange in Electronic Messages with Cross-Platform Routing,” the entire disclosure of which is incorporated herein by reference in its entirety. This application is related to, and incorporates herein by reference in its entirety, co-pending U.S. patent application Ser. No. [Application No. to be inserted by Preliminary Amendment], entitled “Constraint-Adaptive Communication Envelope for Interactive Applications within Resource-Constrained Message Surfaces,” filed on the same day as the present application by the same inventor and claiming the benefit of priority to the same U.S. Provisional Patent Application No. 63/802,464. References herein to “Application 1” or “the co-pending Application 1” refer to said Attorney Docket AS-0001 application. The entirety of the specification, drawings, and claims of said Application 1 is incorporated herein by reference for all purposes including written description and enablement support under 35 U.S.C. § 112.

### COPYRIGHT AND TRADEMARK NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. Trademarks used in the disclosure of the invention, and the applicants, make no claim to any trademarks referenced.

### FIELD OF THE INVENTION

The present disclosure relates to agent-orchestration systems, and more particularly to bridging autonomous software agent protocols across resource-constrained electronic message surfaces by resolving compounding surface-imposed constraints—including byte-ceiling, sandbox, attachment-blocking, user-interface-element-quota, privacy-gate, latency-service-level, and absent-middleware constraints—on agent-to-agent communications, maintaining stateful session context across the protocol-constraint boundary, providing identity verification and credential revocation across the boundary, and providing integrated economic settlement for agent interactions.

### BACKGROUND OF THE INVENTION

Agent-orchestration protocols-including the Model Context Protocol (MCP), Google Agent2Agent (A2A), Google AgentSpace, the OpenAI Agents SDK, LangGraph, and AutoGen—standardize how autonomous software agents exchange context bundles, invoke tools, and negotiate capabilities. These protocols presume delivery rails capable of carrying, for example, 50 KB to 250 KB JSON payloads with no hard byte ceiling.

However, the most widely deployed communication channels impose strict byte limits: push notifications cap at approximately 4,096 bytes, AMP for Email at 102,400 bytes, Microsoft Teams Adaptive Cards at 28,000 bytes, and RCS AgentMessage payloads at 250,000 bytes with text limited to 3,072 characters. Agent orchestration protocols cannot function within these limits because their context bundles, tool invocation payloads, and response data routinely exceed the byte ceilings of constrained channels.

Existing protocol adapters convert between formats but do not enforce byte budgets on the data they pass through. When an agent orchestration response exceeds the target channel's byte ceiling, conventional adapters either truncate the response—destroying semantic completeness—or reject it entirely. No prior system enforces byte-budget constraints on returned agent data through relevance-based selection that preserves semantic completeness while retaining references to excluded elements for later retrieval. No prior system bidirectionally converts between constrained-channel envelopes and agent protocol payloads while enforcing such constraints on the returned data.

Furthermore, existing protocol adapters are stateless—each conversion is independent, with no memory of prior interactions. For multi-turn agent workflows where context accumulates across conversational turns, stateless conversion forces each turn to start cold, losing the negotiation history, tool state, and memory that agents require for meaningful interaction.

Finally, no current agent orchestration protocol provides integrated economic settlement. Protocols reference tool invocations and capability negotiation but do not record per-turn usage fees or success fees. Autonomous agents negotiating on behalf of users—for procurement, customer service, or financial transactions—lack a mechanism to charge for their services within the protocol itself, requiring external billing infrastructure.

Existing identifier-revocation infrastructure (for example, X.509 Certificate Revocation Lists per IETF RFC 5280, Online Certificate Status Protocol per IETF RFC 6960, OAuth 2.0 token revocation per IETF RFC 7009, and DKIM key-rotation announcements per IETF RFC 6376) is designed for credentials issued to long-lived organizational principals and validated by middleware components positioned at the message gateway. None of this infrastructure addresses revocation of agent credentials at the protocol-constraint boundary of a resource-constrained electronic message surface, where (i) no middleware exists at the surface to perform the revocation check, (ii) the credential being revoked may be a short-lived autonomous-agent identifier rather than a long-lived organizational principal, (iii) the revocation must be enforced before the agent's payload is admitted into the bridge's conversion pipeline (otherwise compromised agent operations may be propagated through the bridge before the revocation is observed), and (iv) the revocation event must be propagated across federated bridge instances within an interval shorter than the upstream registry's polling interval, otherwise a revoked agent that re-engages through a different bridge instance circumvents the revocation. No prior system provides agent-credential revocation enforcement bound into the bridge ingress path of a resource-constrained electronic message surface, with cross-instance revocation propagation, per-entry cryptographic auditability, and integration into the bridge's tamper-evident audit ledger.

These constraints compound at the protocol boundary in a manner analogous to the compounding constraints described in the co-pending Application 1. Agent protocols require large payloads that constrained channels reject (the byte-ceiling constraint). Agent runtimes require executable logic—tool calls, function invocations, capability negotiations—that sandboxed surfaces prohibit (the sandbox constraint). Agent session state requires server-side persistence that middleware-free surfaces cannot provide (the middleware constraint). These three constraints interact: the sandbox restriction prevents the agent from executing its logic client-side, forcing all agent computation to occur server-side with results round-tripped through the constrained channel; the byte-ceiling constraint limits how much of the server-side result can be delivered per turn; and the absent middleware means that security, compliance, and identity verification must be applied to the agent's output before transmission rather than at the surface. Each constraint, considered alone, is addressable by isolated workarounds known in the art (for example, gateway-based truncation for the byte ceiling, declarative-only payloads for sandboxed surfaces, or third-party state stores for missing middleware); what excludes autonomous agents from the most widely deployed communication surfaces—email, push notifications, RCS, Adaptive Cards, and legacy electronic data interchange formats—is the requirement that all three constraints be satisfied at once on the same per-turn agent payload. No prior system resolves these compounding constraints to enable agents to conduct multi-turn interactions—including tool invocation, memory accumulation, capability negotiation, and economic settlement—through byte-constrained message surfaces.

Accordingly, there is a need for a bridge that resolves the protocol-constraint boundary between agent-orchestration protocols and resource-constrained electronic message surfaces—including the surface-imposed byte-ceiling, sandbox, attachment-blocking, user-interface-element-quota, privacy-gate, latency-service-level, and absent-middleware constraints, alone or in combination—enabling autonomous agents to operate through channels that were previously inaccessible to agent protocols, while maintaining stateful session context, enforcing surface-imposed constraints on agent-returned data, providing identity verification and credential revocation across the boundary, and providing integrated economic settlement.

### BRIEF SUMMARY OF THE INVENTION

In one or more embodiments, the disclosed system comprises an agent-orchestration bridge that enables autonomous software agents to operate through resource-constrained electronic message surfaces—including email, push notifications, RCS, and productivity-suite cards—that were previously inaccessible to agent-orchestration protocols. The bridge resolves the protocol-constraint boundary between agent protocols (which assume unconstrained channels) and constrained channels (which impose strict byte ceilings, sandbox restrictions limiting executable logic, attachment and remote-content blocking, user-interface element quotas, privacy gates suppressing tracking mechanisms, latency service-level constraints, and an absence of sender-accessible server-side middleware), while preserving stateful session context, enforcing byte-budget compliance on agent-returned data, recording every tool invocation and settlement event in a tamper-evident audit ledger, and enabling integrated economic settlement for agent interactions.

In one embodiment, for a resource-constrained electronic message surface that imposes at least a byte-ceiling constraint, a system resolves the protocol-constraint boundary between the message surface and an agent-orchestration protocol whose payloads exceed the byte ceiling. The system maintains stateful session context across the boundary such that agent memory, tool invocation history, and negotiation state persist across a plurality of conversational turns. The system enforces the channel byte-budget on data returned from the agent protocol by selecting a subset of returned elements based on relevance while retaining references to excluded elements. The system records each tool invocation and economic settlement event in a tamper-evident audit ledger. The system enables an autonomous software agent to conduct a multi-turn agent workflow—including at least three sequential conversational turns with accumulated context—through the resource-constrained message surface, the agent operating through a channel that was previously inaccessible to agent protocols.

In one embodiment, a tool-proxy module invokes external APIs or tools referenced by the agent protocol, with each invocation recorded in the tamper-evident audit ledger, and an economic settlement module calculates usage or success fees for each interaction, enabling agent marketplace economics within byte-constrained message surfaces.

In one embodiment, the system bidirectionally maps agent identity credentials between the envelope's native format and protocol-native representations, preserving trust chains across the protocol-constraint boundary.

In one embodiment, the system maintains a cryptographic hash chain across the protocol-constraint boundary, enabling an auditor to verify the integrity of every content transformation without access to plaintext.

In one embodiment, when capability negotiation with a primary agent-orchestration protocol fails, the system automatically renegotiates using a next-priority protocol from a fallback list.

In one embodiment, a method includes resolving the protocol-constraint boundary between a resource-constrained message surface and an agent-orchestration protocol, maintaining stateful session context, enforcing the byte-budget on returned data, and enabling an autonomous software agent to conduct a multi-turn agent workflow through the message surface.

In one embodiment, the system enables cross-organizational agent communication through universally routable resource-constrained message surfaces (such as email via SMTP) without bilateral application-programming-interface integration between the participating organizations, with each organization operating its own bridge instance and converting between its agent's protocol-native format and the constrained-channel envelope format independently.

In one embodiment, the resource-constrained electronic message surface operates as an agent communication channel—either alongside a human-visible interface or as an agent-only data channel with no human-visible rendering—enabling autonomous software agents to discover, query, and transact through standardized constrained-channel endpoints with byte-budget compliance, identity verification, and audit-recorded interaction.

In one embodiment, the system maintains an identifier-revocation service that monitors the validity of agent credentials across the protocol-constraint boundary and rejects communication envelopes from agents whose credentials have been revoked, with each revocation event recorded in the tamper-evident audit ledger as a distinct entry including at least the revoked agent identifier, a revocation reason indicator drawn from a defined enumeration, and a cryptographic signature.

### BRIEF DESCRIPTION OF THE DRAWINGS

FIG. 1 is a block diagram illustrating an agent-orchestration bridge system, in accordance with the embodiments of the present disclosure.

FIG. 2 is a sequence diagram illustrating a bridge handshake between a resource-constrained message surface and an agent-orchestration endpoint, in accordance with the embodiments of the present disclosure.

FIG. 3 is a block diagram illustrating a byte-budget enforcer operating on agent-returned data, in accordance with the embodiments of the present disclosure.

FIG. 4 is a diagram illustrating bidirectional identity mapping across a protocol-constraint boundary, in accordance with the embodiments of the present disclosure.

FIG. 5 is a diagram illustrating a cross-boundary hash chain maintained across a protocol-constraint boundary, in accordance with the embodiments of the present disclosure.

FIG. 6 is an architecture diagram illustrating a resource-constrained message surface functioning as an agent communication channel, in accordance with the embodiments of the present disclosure.

FIG. 7 is a block diagram illustrating a cross-organizational agent relay via a resource-constrained message surface, in accordance with the embodiments of the present disclosure.

### DETAILED DESCRIPTION OF THE INVENTION

The following detailed description illustrates exemplary embodiments. The described examples are not intended to limit the scope of the invention. “In one embodiment” indicates that the described feature is not required in every embodiment.

### The Constraint Boundary Problem

Agent-orchestration protocols assume unconstrained delivery channels. When an agent operating through MCP, A2A, or a functionally equivalent protocol generates a response including tool results, memory updates, event logs, and policy directives, the combined payload routinely exceeds 50 KB. This payload cannot be delivered through a push notification (4 KB), an AMP email (102 KB minus the application itself), or a Teams Adaptive Card (28 KB) without either truncation or rejection.

In one embodiment, the disclosed system bridges this gap by interposing agent-orchestration bridge system 1400 at the boundary between a resource-constrained message surface and an agent-orchestration endpoint. Bridge system 1400 enforces the channel byte-budget on data flowing in both directions across this boundary.

### Definitions

As used herein, “agent-orchestration bridge” refers to a stateful intermediary that interposes at the protocol-constraint boundary between a resource-constrained electronic message surface and an agent-orchestration endpoint, the bridge being structurally and operationally distinct from a stateless protocol adapter. Whereas a stateless adapter performs an independent conversion for each request without preserving state across requests, an agent-orchestration bridge maintains a session store, a per-session canonical-action representation, a tamper-evident audit ledger interface, an economic-settlement subsystem, and a byte-budget-enforcement subsystem that operates on agent-returned data prior to delivery through the constrained surface. The agent-orchestration bridge thereby enables multi-turn agent workflows that require accumulated session context, tool-invocation history, capability-negotiation state, and economic settlement—none of which a stateless adapter can preserve.

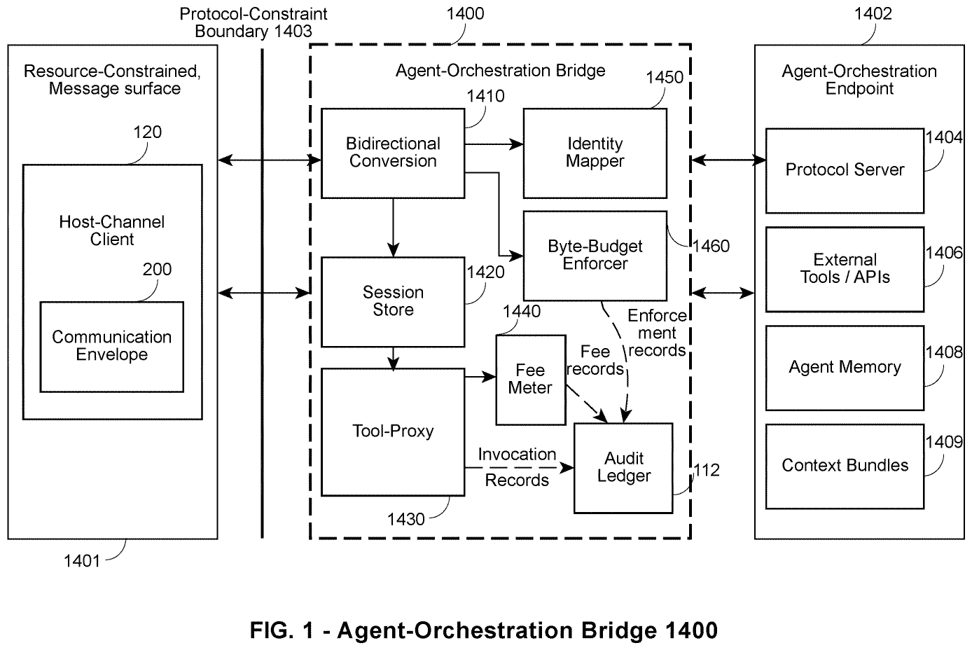

As used herein, “protocol-constraint boundary” refers to the architectural interface between a constrained zone—including resource-constrained electronic message surfaces (for example, AMP for Email at approximately 102,400 bytes, push notifications at approximately 4,096 bytes, Adaptive Cards at approximately 28,000 bytes, RCS at approximately 250,000 bytes, legacy electronic data interchange formats including EDI X12, HL7v2, SWIFT MT, and FIX whose per-segment-or-field constraints function as the analogue of the channel byte-budget, and machine-readable code presentations including Quick Response (QR) codes, Data Matrix patterns, PDF417 barcodes, and Aztec codes)—and an unconstrained zone—including agent-orchestration protocols (for example, the Model Context Protocol, Google Agent2Agent, Google AgentSpace, OpenAI Agents SDK, LangGraph, AutoGen, and functionally equivalent protocols) whose context bundles routinely range from 50 KB to 250 KB or more. Protocol-constraint boundary 1403 of FIG. 1 marks this interface, and bridge system 1400 enforces channel byte-budget B and other surface-imposed constraints on data crossing the boundary in both directions. The terms “resource-constrained electronic message surface” (the full term defined in this disclosure), “resource-constrained message surface,” and “constrained message surface” are used interchangeably throughout this specification and the appended claims to refer to the same defined element; selection between full and abbreviated form in any given recitation is for readability only and does not import any narrowing or distinguishing scope.

As used herein, “economic settlement” refers to the per-turn calculation, recording, and disposition of usage-based fees and success-conditioned micropayments accumulated by an autonomous software agent during the course of conducting an agent workflow through a resource-constrained message surface. Economic settlement includes (a) per-turn fee metering by fee meter 1440 against a tariff configured for the agent's capability set; (b) accumulation of pending fees into a session-scoped settlement record persisted in session store 1420; (c) commit of the settlement record to tamper-evident audit ledger 112 as a FeeMeterEvent at workflow completion or upon explicit settlement triggers; and (d) downstream disbursement to the agent operator according to the operator's configured payout mechanism. Economic settlement as used herein is internal to the bridge system and does not refer to external billing or payment-processing infrastructure operated independently of the bridge.

As used herein, “context bundle” refers to the agent-orchestration protocol's native payload format carrying the union of agent memory, tool-invocation history, capability-negotiation state, and the per-turn structured intent or response. The context bundle is sized for unconstrained channels—typically 50 KB to 250 KB or more—and encodes per-protocol structures (for example, MCP “context” arrays, A2A “Artifact” objects, AgentSpace session-context payloads). Bridge system 1400 receives context bundles inbound from agent-orchestration endpoint 1402 and produces context bundles outbound from session store 1420 by serializing the canonical-action representation into the destination protocol's wire format.

As used herein, “canonical-action schema” refers to a protocol-neutral intermediate representation maintained by bridge system 1400 in session store 1420 that captures the four elements of agent-session continuing state independently of any specific agent-orchestration protocol: (i) a canonical action-identifier field; (ii) a canonical-tool-invocation-history field preserving an ordered sequence of per-turn tool invocations with tool name, arguments, result, and timestamp; (iii) a canonical-memory field preserving conversational memory; and (iv) a canonical-settlement-record field preserving outstanding economic-settlement obligations. The canonical-action schema enables protocol fallback, cross-protocol agent communication, and bridge restart without information loss with respect to agent memory, tool-invocation history, or settlement records. Within the canonical-action schema, safetyHash corresponds to hash H₁ of the cross-boundary hash chain of paragraphs [0073]-[0076], and edgeId corresponds to the session-edge identifier component of the canonical action-identifier field.

### System Architecture

FIG. 1 is a block diagram illustrating agent-orchestration bridge system 1400. Referring now to FIG. 1, agent-orchestration bridge system 1400 sits at the boundary between resource-constrained message surface 1401—such as an email renderer, push notification handler, RCS client, productivity-suite card renderer, mobile or web advertising display surface, connected-television overlay, in-application interstitial, embedded web-page surface, or legacy electronic data interchange endpoint—and agent-orchestration endpoint 1402, which may implement any of: Model Context Protocol (MCP), Google A2A, Google AgentSpace, OpenAI Agents SDK, LangGraph, AutoGen, or a functionally equivalent protocol. Agent-orchestration endpoint 1402 includes protocol server 1404 (the agent's protocol-native runtime), external tools and APIs 1406 (invocable through tool-proxy module 1430), agent memory 1408 (persistent agent state across conversations), and context bundles 1409 (the protocol-native payload format ranging from 50 KB to 250 KB or more).

As used herein, the phrase “a functionally equivalent protocol” when referring to an agent-orchestration protocol refers to any protocol, whether presently existing or hereafter developed, that supports at least the following four capabilities: (i) capability negotiation between autonomous software agents, including negotiation of available tools and supported operations; (ii) tool-invocation semantics that permit an agent to invoke an external tool or application-programming-interface and receive structured results; (iii) context-bundle transmission capable of carrying payloads that exceed the byte-ceiling constraint of at least one of the resource-constrained electronic message surfaces enumerated in paragraph [0034]; and (iv) persistence of stateful session context including agent memory, tool-invocation history, and negotiation state—across a plurality of conversational turns. An agent-orchestration protocol satisfying each of (i), (ii), (iii), and (iv) is functionally equivalent within the meaning of this disclosure to the enumerated protocols Model Context Protocol (MCP), Google A2A, Google AgentSpace, OpenAI Agents SDK, LangGraph, and AutoGen, regardless of wire format, payload schema, or authoritative publisher.

Bridge system 1400 includes bidirectional conversion module 1410, session store 1420, tool-proxy module 1430, fee meter 1440, identity mapper 1450, and byte-budget enforcer 1460. Bridge system 1400 further includes—or is communicatively coupled to—tamper-evident audit ledger 112. In one embodiment, tamper-evident audit ledger 112 is a dedicated ledger instance owned and operated by bridge system 1400 (for example, a standalone bridge deployment maintaining its own append-only hash-linked ledger and access-control envelope). In another embodiment, tamper-evident audit ledger 112 is a shared ledger instance jointly serving bridge system 1400 and the constraint-adaptive messaging system described in the co-pending Application 1, in which case the shared ledger is operated under a unified access-control envelope (for example, role-scoped append permissions for each writer, per-tenant read partitioning, and a common cryptographic trust anchor governing entry signatures) such that no participating system can mutate or read entries belonging to another participating system outside its authorized scope. Whether dedicated or shared, the ledger satisfies the same tamper-evident, hash-linked, append-only properties throughout this disclosure. Protocol-constraint boundary 1403 is the interface between resource-constrained message surface 1401 and bridge system 1400, across which byte-budget constraints are enforced.

Data flowing through bridge system 1400 is subject to the two-phase delivery security model described in the co-pending Application 1: the initial communication envelope is delivered through the standard message transport carrying only the application skeleton and typed placeholders, while sensitive agent data—including tool results including regulated information, identity credentials, and economic settlement records—flows exclusively through the secure runtime channel established when the host-channel client opens the message and initiates authenticated HTTPS communication with the envelope generator. The two-phase mechanism operates as follows: (a) the initial communication envelope is transmitted via the standard message delivery transport with typed placeholder assets substituted for all sensitive data elements, ensuring the envelope fits within channel byte-budget B and includes no sensitive data in transit; (b) upon a host-channel client rendering the communication envelope, the embedded application logic causes the host-channel client to establish an authenticated secure channel (e.g., authenticated HTTPS from an AMP form POST, an Adaptive Card Action.Execute callback, or equivalent surface-native mechanism) directly to the envelope generator, bypassing the standard message delivery transport; and (c) sensitive data is delivered exclusively through the authenticated secure channel after the recipient satisfies authentication requirements specified by a data-protection compliance profile applicable to the agent-mediated data. The data-protection compliance profile is dynamically selectable from healthcare (HIPAA), financial (GLBA), personal information (GDPR), or other regulatory mandates, and specifies the authentication method and assurance level the recipient must satisfy before sensitive agent-mediated data is disclosed. This ensures that agent-mediated interactions involving sensitive data (such as procurement negotiations with pricing terms, healthcare agent workflows with PHI, or financial agent transactions with account details) comply with the applicable data-protection regime through the same two-phase architecture, with the bridge system 1400 enforcing the channel byte-budget B on both phases.

Referring to FIG. 1, bridge system 1400 operates across three zones. The constrained zone on the left includes host-channel client 120 and the communication envelope, which is constrained to size less than or equal to B. The bridge zone in the center houses all bridge components (1410, 1420, 1430, 1440, 1450, 1460, 112). The unconstrained zone on the right includes the agent-orchestration endpoint 1402, which communicates via protocol-native context bundles that may range from 50 KB to 250 KB or more. Bidirectional data flows cross the constraint boundary in both directions: outbound (envelope to protocol format via conversion module 1410) and inbound (agent response through byte-budget enforcer 1460 back into a refreshed envelope). Byte-budget enforcer 1460 applies the channel byte-budget B to data returned from the agent endpoint, ensuring that agent responses that exceed B are reduced through relevance-based selection before delivery through the constrained message surface. As used herein, “channel byte-budget B” refers to the maximum serialized size, in bytes, that the target message surface will accept for a single delivered communication envelope, including representative values of approximately 102,400 bytes for AMP for Email, approximately 4,096 bytes for push notification services, approximately 28,000 bytes for Microsoft Teams Adaptive Cards, and approximately 250,000 bytes for Google's RCS Business Messaging API. This definition is consistent with the corresponding definition in Application 1 (incorporated by reference per the cross-reference section above).

### Bidirectional Conversion With Stateful Session

Bidirectional conversion module 1410 converts between the communication envelope's format and a context representation compatible with the selected agent-orchestration protocol. Critically, module 1410 maintains stateful session context in session store 1420 across conversational turns. Session store 1420 preserves agent memory, tool invocation history, negotiation state, and accumulated context so that each subsequent turn builds on prior interactions rather than starting cold.

This stateful session maintenance across the constrained-channel boundary distinguishes the disclosed system from conventional protocol adapters, which are stateless and treat each conversion independently. For multi-turn agent workflows—such as iterative procurement negotiations, customer service escalations, or multi-step regulatory filings—stateless conversion renders the agent unable to reference prior turns, requiring either full retransmission of the accumulated context on every turn (which may exceed the byte budget) or complete abandonment of conversational continuity.

Session store 1420 persists the following state across conversational turns: (a) the agent's accumulated memory patches—key-value pairs representing facts, preferences, or decisions the agent has learned during the conversation; (b) tool invocation history—a log of which tools were called, with what parameters, and what results were returned, enabling the agent to avoid redundant invocations; (c) capability negotiation state—the negotiated set of tools, memory resources, and sampling capabilities established during the initial handshake, avoiding renegotiation on each turn; and (d) accumulated context window—the running context that the agent requires for coherent multi-turn reasoning, pruned to fit within the byte budget. In an example embodiment, session store 1420 is implemented as a keyed store indexed by conversation identifier, with a configurable time-to-live after which idle sessions expire. The configured time-to-live is selected per workflow class to match the workflow's expected interaction tempo—for example, on the order of thirty minutes for short-lived customer-service interactions, on the order of hours for collaborative document review, on the order of days for multi-party procurement negotiations spanning supplier response cycles, and on the order of weeks for regulatory-filing workflows that include external response windows—and may be reset on each turn so that idle expiration is measured from the most recent recipient or agent activity rather than from session inception.

In one embodiment, conversion module 1410 applies a schema-translation mapping that transforms fields between the envelope's native format and the structural conventions of the selected agent-orchestration protocol. The mapping is bidirectional, enabling a single conversational application to interoperate with multiple agent protocols without protocol-specific application logic.

In one embodiment, the agent-orchestration endpoint 1402 of paragraph [0034] is backed by a plurality of model instances differing in latency, accuracy, cost, deployment region, or compliance posture, and the outbound communication envelope from bridge system 1400 to agent-orchestration endpoint 1402 includes a model-selection header. The model-selection header includes at least (i) a target-latency-class field selected from a defined enumeration (for example, interactive, near-real-time, or batch), (ii) a target-cost-class field selected from a defined enumeration aligned with the per-token-rate, per-API-call-rate, and per-cpu-millisecond-rate components of paragraph [0063], (iii) a compliance-posture field referencing the data-protection compliance profile of paragraph [0037], and (iv) a fallback-policy field describing the model-instance preference order to be applied when the primary model instance is unavailable, overloaded, or returns a refusal. Bridge system 1400 routes the context bundle to the model instance satisfying the model-selection-header constraints, records the selection decision in tamper-evident audit ledger 112 as a ModelSelection event, and applies fee meter 1440 against the rate table specific to the selected model instance. Where capability negotiation with the primary model instance fails per the fallback-policy field, bridge system 1400 selects the next-priority model instance and records a corresponding ModelFallback event. This model-selection-header workflow is architecturally orthogonal to the agent-orchestration-protocol fallback of paragraph [0102]—the protocol fallback selects between MCP, A2A, AgentSpace and the like, while the model-selection-header workflow selects between model instances reachable through whichever protocol is in effect.

As an illustrative example of schema translation for the Model Context Protocol (MCP): the envelope's sliding-window shard (a byte-counted array of typed context items) is mapped to MCP's context array of resource URIs; the envelope's replay-detection token fields (convId, platformId, recipientId) are mapped to MCP's session metadata headers; the envelope's placeholder manifest pointers are mapped to MCP resource URIs with a custom scheme (e.g., “manifest://convId/assetId”) that the bridge resolves on demand; and tool invocation requests from the MCP server are mapped back to envelope action elements constrained by byte-budget B. On the return path, MCP tool results (which may be arbitrarily large JSON objects) pass through the byte-budget enforcer before being injected into the refreshed envelope. For Google A2A, the mapping differs: the envelope's conversation state maps to A2A's task context, the replay-detection token maps to A2A's authentication header, and A2A's streaming events are accumulated in session store 1420 until a complete turn can be assembled into a refreshed envelope.

### Bridge Handshake Sequence

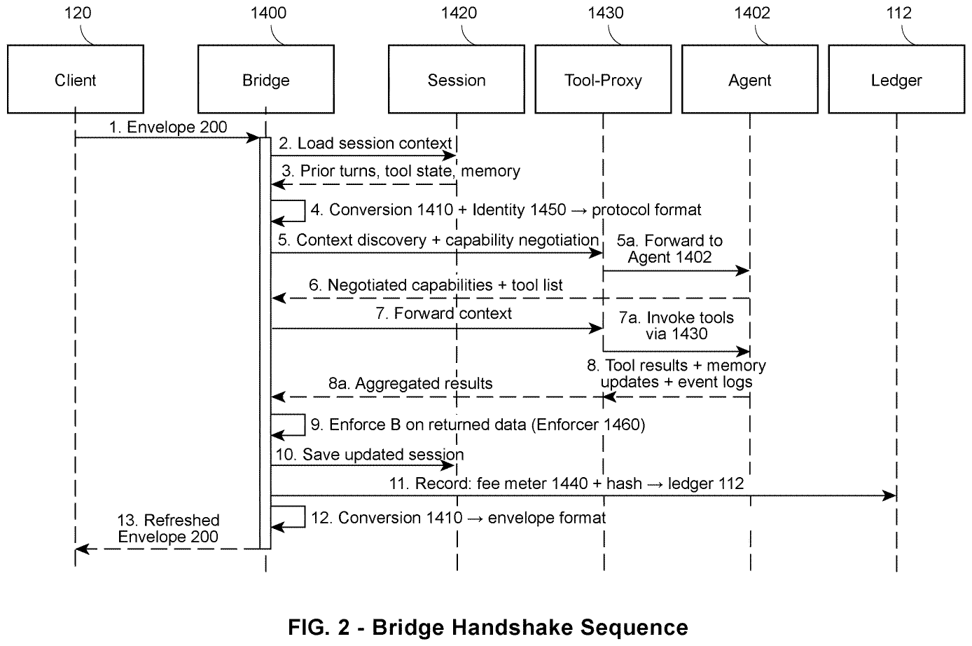

FIG. 2 is a sequence diagram illustrating a bridge handshake across six actors, namely host-channel client 120, bridge system 1400, session store 1420, tool-proxy module 1430, agent-orchestration endpoint 1402, and tamper-evident audit ledger 112. Referring to FIG. 2, the complete bridge handshake proceeds in five phases corresponding to the thirteen sequence steps depicted in the figure. The phases are described below in operational order.

Session initialization (steps 1-3). At step 1, host-channel client 120 transmits a communication envelope (size less than or equal to B) to bridge system 1400 over the standard message delivery transport followed by establishment of the secure runtime channel. At steps 2-3, bridge system 1400 loads the existing session context from session store 1420, including agent memory, prior-turn tool-invocation history, capability-negotiation state, and outstanding economic-settlement records. The session context is keyed by conversation identifier extracted from the envelope's replay-detection token. If no prior session exists for the conversation identifier (a new agent workflow), session store 1420 returns an empty session record and bridge system 1400 initializes a new canonical-action representation that will be populated through the subsequent phases. The session-load operation must complete before protocol conversion proceeds because the converted context bundle must include the accumulated session state to preserve agent memory across turns; loading session state at this phase rather than at conversion time is what distinguishes a stateful agent-orchestration bridge from a stateless protocol adapter.

Protocol conversion and capability negotiation (steps 4-6). At step 4, bidirectional conversion module 1410 converts the communication envelope into the agent-orchestration protocol's wire format using the bidirectional protocol-to-canonical mapping table of paragraphs [0083]-[0084]. The conversion produces a context bundle in the destination protocol's native format including the loaded session state plus the new turn's user input. At steps 5-6, bridge system 1400 performs context discovery and capability negotiation with agent-orchestration endpoint 1402—exchanging tool manifests, memory-resource permissions, and sampling capabilities. Capability negotiation is performed once per session (or upon protocol fallback per paragraph [0102]) with the negotiated capability set persisted in session store 1420 to avoid renegotiation on each subsequent turn. Capability negotiation resolves the operational interface between bridge system 1400 and the agent endpoint for the duration of the session.

Tool invocation and result return (steps 7-8). At step 7, bridge system 1400 forwards the accumulated context bundle (which may exceed channel byte-budget B because the agent-orchestration endpoint operates in the unconstrained zone) to agent-orchestration endpoint 1402 through the protocol-native transport. Agent-orchestration endpoint 1402 processes the context bundle and may invoke external tools or APIs through tool-proxy module 1430, with each tool invocation flowing through the proxy to record the invocation in tamper-evident audit ledger 112. At step 8, agent-orchestration endpoint 1402 returns its response—including tool results, memory updates, event logs, and policy directives—which routinely totals 50 KB to 250 KB or more. The response flows back through tool-proxy module 1430, which validates that any tool invocations referenced in the response correspond to invocations recorded in the audit ledger; tool-proxy module 1430 may further apply per-tool size caps to prevent any single tool from monopolizing the channel byte-budget at byte-budget-enforcement time.

Byte-budget enforcement and session update (steps 9-10). At step 9, byte-budget enforcer 1460 enforces channel byte-budget B on the agent-returned data per the algorithm of paragraph of the present application. Enforcer 1460 ranks returned elements by relevance, selects a subset whose cumulative serialized size fits within B, and replaces excluded elements with typed placeholder assets (each carrying a content-type identifier, a condensed surrogate, and an authenticated retrieval reference, where the authenticated retrieval reference functions as a server-signed manifest cursor that the bridge validates and resolves on demand against the corresponding archived element, in accordance with the typed-placeholder-asset and manifest-cursor disclosures of the co-pending Application 1 corresponding, as filed, to the typed-placeholder-asset definition recited at Application 1 paragraph [0037] and to the manifest-cursor placeholder-hydration mechanism recited at Application 1 paragraphs [0068]-[0069]). The byte-budget enforcement at this phase is what distinguishes the agent-orchestration bridge from a stateless protocol adapter, which would either truncate or reject responses exceeding B; enforcer 1460 instead preserves agent workflow continuity by retaining all elements either in the budget-compliant envelope directly or as authenticated retrieval references hydratable through the secure runtime channel. At step 10, the updated session—including the new agent memory, the new tool-invocation history, and the budget-compliant result subset—is committed to session store 1420 keyed by the conversation identifier.

Settlement, ledger recording, and envelope refresh (steps 11-13). At step 11, fee meter 1440 computes the per-turn usage fee from the tariff configured for the agent's capability set and the resources consumed (tool invocations, memory operations, byte volume); the computed fee is appended to tamper-evident audit ledger 112 as a FeeMeterEvent including at least the conversation identifier, the agent identifier, the per-turn fee value, the cumulative-fee value, the tariff identifier, and a fee timestamp. The tool-invocation events, agent-response content hash, and the FeeMeterEvent are committed atomically to the ledger before envelope production proceeds, preserving the tamper-evident chain of every interaction. At step 12, bidirectional conversion module 1410 converts the budget-compliant result subset (now in the canonical-action representation) back into the constrained-channel envelope format using the destination-side mapping (canonical→wire). The converted envelope embeds the typed placeholder assets produced by step 9 and the refreshed session-state metadata required by host-channel client 120 to render the next interaction turn. At step 13, the refreshed envelope (size less than or equal to B) is delivered to host-channel client 120 through the appropriate channel adapter set, completing the handshake. The host-channel client renders the refreshed envelope, the recipient observes the updated interactive surface, and any subsequent interaction triggers a new handshake cycle that reuses the now-updated session context.

### Byte-Budget Enforcement on Returned Data

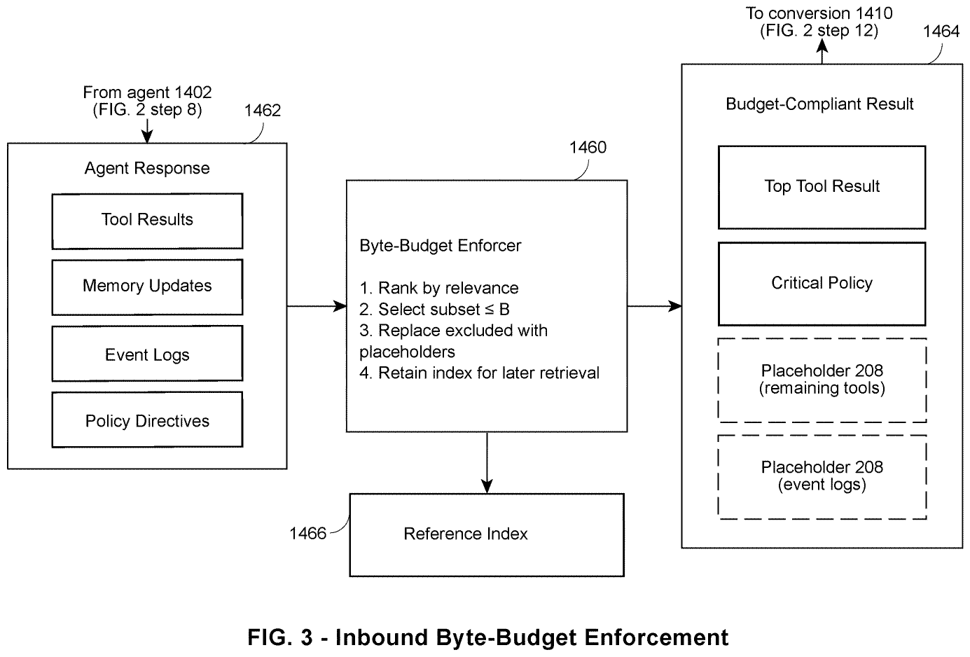

FIG. 3 is a block diagram illustrating byte-budget enforcer 1460 operating on agent-returned data within bridge system 1400. Referring to FIG. 3, when bridge system 1400 receives data returned from agent-orchestration endpoint 1402, the returned data arrives as agent response 1462—including tool results, memory updates, event logs, and policy directives—which may exceed the channel byte-budget B. Byte-budget enforcer 1460 enforces B on this returned data, producing budget-compliant result 1464 including retained elements and typed placeholders for excluded elements, together with reference index 1466 enabling on-demand retrieval of excluded elements. This enforcement is applied on the INBOUND direction (agent→message surface), not just the outbound direction.

Enforcement includes ranking returned data elements based on relevance, selecting a subset whose cumulative size fits within B, and retaining references to excluded elements enabling later retrieval. Lower-relevance elements are replaced with typed placeholders, as described in the co-pending Application 1.

Where the agent-orchestration endpoint's returned data includes a plurality of discrete interactive elements (for example, a plurality of user-selectable action buttons, a plurality of product-variant selections, or a plurality of tool-choice affordances) whose count would exceed a user-interface element quota imposed by the target message surface, byte-budget enforcer 1460 additionally applies typed-placeholder consolidation analogous to the mechanism described in the co-pending Application 1 at the UI-element-quota disclosure recited at Application 1 paragraph [0097] and the contiguous embodiment paragraphs at Application 1 paragraphs [0098]-[0099]. In one embodiment, byte-budget enforcer 1460 queries the platform descriptor for the target surface's element-count limit (for example, three for an RCS Universal Profile quick-reply quota, five for an Apple Messages for Business quick-reply quota, six for a Microsoft Teams Adaptive Card primary-action quota, or ten for a WhatsApp Business Platform list-picker quota), and where the agent response's interactive-element count exceeds that limit, the enforcer substitutes a plurality of discrete interactive elements with a single typed placeholder asset that (i) includes a content-type identifier categorizing the class of consolidated elements (such as “agent-tool-choices-overflow,” “agent-action-buttons-overflow,” or “agent-product-suggestions-overflow”), (ii) occupies a single addressable structural slot within the refreshed envelope, and (iii) upon recipient interaction with the placeholder, causes the host-channel client to retrieve the consolidated interactive elements through the same authenticated runtime channel used by the bridge to communicate with the agent-orchestration endpoint, such that the consolidated elements' values do not traverse the standard message delivery transport that carried the refreshed envelope. This UI-element-quota consolidation is architecturally complementary to the byte-ceiling enforcement of paragraphs [0051]-[0057]: both mechanisms use typed placeholder assets within the refreshed envelope to satisfy a resource-constrained message-surface constraint while preserving agent workflow continuity across turns.

This inbound byte-budget enforcement is architecturally essential because agent responses are unbounded—an agent may return megabytes of tool output, memory patches, or event logs that cannot fit within a 4 KB push notification or a 102 KB email. Without inbound enforcement, the bridge would be unable to deliver agent responses through constrained channels. Similarly, agent responses proposing more interactive elements than the target surface's element-count quota permits (such as an agent returning ten action options for a three-button RCS surface) would fail to render without the UI-element-quota typed-placeholder consolidation of paragraph [0053].

Operations of fee meter 1440 and byte-budget enforcer 1460 are sequenced strictly within each agent turn so that no tool invocation traverses byte-budget enforcement before it has been authorized by fee-meter pre-invocation evaluation. In one embodiment the per-turn ordering is: (i) fee-meter pre-invocation evaluation of the prospective tool invocation set per paragraph [0063]; (ii) refusal handling for any invocation that would breach the cost cap (per the workflow-continuity provisions of paragraph [0063]); (iii) execution of authorized tool invocations through tool-proxy module 1430; (iv) fee-meter post-invocation reconciliation of actual token, API-call, inference, and compute-time consumption against the pre-invocation estimate, with corrective FeeMeterEvent entries appended to tamper-evident audit ledger 112 if the actual exceeds the estimate by more than a configurable tolerance; and (v) byte-budget enforcer 1460 application to the resulting agent response per the algorithm of paragraph [0056]. Because byte-budget enforcer 1460 operates only after step (iii) (and not before step (i)), the enforcer cannot trim a response so as to cause a tool invocation to appear in the budget-compliant subset that the fee meter had not pre-authorized; conversely, because the fee meter cannot pre-authorize tool invocations that have not yet been generated, the post-invocation reconciliation step (iv) provides the cryptographic record of consumed-versus-estimated cost from which downstream dispute-resolution can verify pre-invocation conformance.

Referring to FIG. 3, in one embodiment, byte-budget enforcer 1460 operates according to the following algorithm: (1) receive the complete set of returned data elements D from the agent-orchestration endpoint; (2) classify each element d in D by type—tool results, memory updates, event logs, and policy directives; (3) rank elements by relevance, where tool results directly responsive to the current user action receive highest relevance, policy directives affecting session state receive second-highest relevance, and historical event logs and background memory updates receive lowest relevance; (4) initialize a result set R and set currentSize to zero; (5) for each element d in relevance-descending order, if currentSize plus the serialized size of d does not exceed B, add d to R and increment currentSize; otherwise, replace d with a typed placeholder retaining a retrieval reference; (6) emit R with total serialized size not exceeding B, together with a reference index enabling on-demand retrieval of excluded elements.

In an illustrative example, an agent-orchestration endpoint returns approximately 60 KB of data including 35 KB of tool results, 12 KB of memory updates, 8 KB of event logs, and 5 KB of policy directives. For delivery through a push notification surface with B=4,096 bytes, byte-budget enforcer 1460 ranks the returned elements and selects the highest-relevance tool result (approximately 2 KB) and a critical policy directive (approximately 1 KB), replacing the remaining tool results, all memory updates, and all event logs with typed placeholders (approximately 0.4 KB each). The resulting budget-compliant payload of approximately 3.8 KB fits within B=4,096 bytes. For delivery through an AMP for Email surface with B=102,400 bytes, the same 60 KB response fits entirely without enforcement, and byte-budget enforcer 1460 passes all elements through unmodified.

### Tool-Proxy Module

Tool-proxy module 1430 invokes external APIs, databases, or autonomous tools referenced by the agent-orchestration protocol. The invocation parameters are extracted from the communication envelope, the tool is invoked through the protocol's native mechanism, and the results are returned through the byte-budget enforcement pipeline.

Each tool invocation is recorded in tamper-evident audit ledger 112 together with a tool identifier, invocation timestamp, input hash, and output hash. This creates a verifiable record of every tool action taken on behalf of the user within the message surface.

In one embodiment, tool-proxy module 1430 enforces the channel byte-budget on tool results before they are incorporated into the refreshed communication envelope, preventing any single tool response from consuming the entire byte budget.

### Economic Settlement

Fee meter 1440 calculates a fee—such as a usage fee, success fee, per-transaction fee, tiered fee, percentage-based fee, or other fee structure—associated with each tool invocation or agent turn. The fee record is appended to tamper-evident audit ledger 112 and is available for reconciliation independently of the particular agent-orchestration protocol employed.

This integrated economic settlement enables agent marketplace economics within byte-constrained message surfaces. An autonomous procurement agent negotiating on behalf of a user can charge a per-turn usage fee; a customer service agent resolving a dispute can charge a success fee tied to the resolution. The fee records are part of the same tamper-evident audit chain as the conversational data, providing verifiable billing without external infrastructure.

In one embodiment, fee meter 1440 is configured as a micropayment fee meter that calculates per-turn usage fees according to a formula combining a token-count component, an application-programming-interface-call-count component, an inference-cost component (the compute cost attributable to LLM-backed inference operations, separately metered from non-inference API-call cost so that token-priced or per-inference-priced model invocations are tracked as a distinct cost category), and a compute-time component, each component multiplied by a configurable per-unit rate. For example, the per-turn cost is calculated as “turnCost=(tokens×tokenRate)+(apiCalls×callRate)+(inferences×inferenceRate)+(cpuMs×cpuRate)”, where “inferences” counts the number of model-inference operations attributable to the turn (for example, distinct LLM completions, embedding computations, or model-served evaluations) and “inferenceRate” is set independently of “callRate” to reflect the materially different cost basis of model-inference compute versus generic API-call compute. The rates support sub-cent precision—for example, a “tokenRate” of US $0.000002 per token, or a “callRate” of US $0.0001 per API call—enabling high-resolution cost tracking at the per-token or per-millisecond granularity characteristic of agent-based interactions. A per-conversation cost cap is configurable to a value below one cent per turn (for example, 0.5 US¢ per turn) or to a value below one United States dollar per conversation (for example, 50 US¢ per conversation), depending on the deployment's sensitivity to sub-cent precision versus broader cost-containment objectives. The per-conversation cost cap is enforced synchronously and pre-invocation: before each agent turn or tool invocation is executed, the fee meter evaluates the prospective “turnCost” against the remaining cost-cap budget for the conversation, and if the prospective “turnCost” would cause the accumulated fee for the conversation to exceed the configured cost cap the fee meter refuses the invocation and returns a structured refusal response to the invoking agent or tool-proxy component. This pre-invocation refusal is architecturally distinct from post-hoc aggregated-billing alerts (in which budget overruns are detected after resource consumption) because the refusal prevents the computational resource from being consumed in the first place, protecting the deployment against unbounded cost accumulation arising from recursive agent invocations, prompt-injection attacks directing the agent to exhaust its budget, or logic loops that would otherwise silently accumulate sub-cent charges until a macroscopic account-level budget alarm triggers. Each fee-metering event—whether the evaluation resulted in an allowed invocation or a refused invocation—is appended to tamper-evident audit ledger 112 as a FeeMeterEvent including at least a turn identifier, a computed per-turn cost value at sub-cent precision, a cumulative-cost value across the conversation, a cost-cap-remaining value, and an allowed-or-refused indicator. The micropayment fee meter operates independently of the particular agent-orchestration protocol employed (MCP, A2A, AgentSpace, or any functionally equivalent protocol) and independently of the particular settlement rail employed (stablecoin payment rails such as USDC, card-network settlement, card-alternative settlement, or aggregated invoicing), such that the same fee-metering architecture and the same pre-invocation refusal logic applies across protocols and across settlement rails. When the fee meter refuses an invocation, bridge system 1400 preserves agent workflow continuity rather than terminating the workflow: in one embodiment the bridge produces, in lieu of the refused tool's would-be response, a typed placeholder asset of a “fee-meter-refusal” content-type category that includes (i) the structured refusal record (refused-tool identifier, evaluated turn-cost, cost-cap-remaining, and refusal reason), (ii) an authenticated retrieval reference through which the recipient or recipient's authorizing principal may, after explicit out-of-band cost-cap adjustment, request re-evaluation of the refused invocation, and (iii) a continuation cursor enabling subsequent turns of the workflow to proceed without re-establishing the session context. In another embodiment the bridge surfaces a structured cost-cap-exceeded envelope that offers the recipient a defined set of continuation options—for example, raise the per-conversation cost cap by an authorized amount, downgrade to a lower-cost tariff, or terminate the workflow and commit any accumulated fees—with the selected option recorded as a CostCapDecision entry in tamper-evident audit ledger 112. In each embodiment the workflow's accumulated session context (memory, tool history, settlement record) remains in session store 1420 so that any subsequent re-engagement after a cost-cap adjustment resumes from the refused turn rather than restarting cold.

In an example embodiment, fee meter 1440 maintains a fee ledger entry for each tool invocation including: tool identifier, invocation timestamp, input token count (for LLM-backed tools), output token count, computed usage fee (based on a configurable rate table), and a cumulative session total. When a conversation turn culminates in a measurable outcome (e.g., a completed purchase, a resolved support ticket, or a signed document), fee meter 1440 appends a success-fee record including: outcome type, outcome value, fee percentage or flat amount, and computed success fee. Both usage fees and success fees are hashed into tamper-evident audit ledger 112, enabling downstream reconciliation without trusting any single party's accounting.

No current agent-orchestration protocol provides this capability. Current agent-orchestration protocols, such as MCP, A2A, and AgentSpace, define tool invocation and context exchange but leave economic clearing undefined. This omission prevents autonomous agents from operating as marketplace participants within byte-constrained channels.

### Identity Across Protocol Boundaries

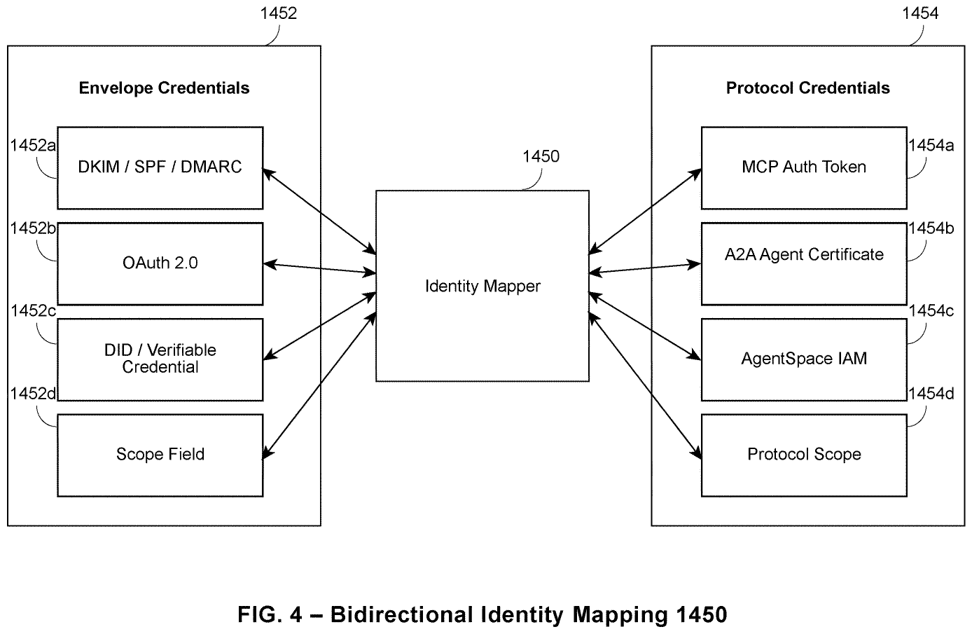

FIG. 4 is a diagram illustrating bidirectional identity mapping by identity mapper 1450 across the protocol-constraint boundary, with envelope credentials 1452 and protocol credentials 1454. Referring to FIG. 4, identity mapper 1450 bidirectionally maps agent identity credentials between the envelope's native credential format and a protocol-native identity representation recognized by the selected agent-orchestration protocol. As shown in FIG. 4, envelope credentials 1452 on the left side of the diagram include four credential types: DKIM/SPF/DMARC domain signature 1452a, OAuth 2.0 client-credential access token 1452b, Decentralized Identifier (DID) with Verifiable Credential 1452c, and scope field 1452d. Each is connected via bidirectional arrows through identity mapper 1450 at the center to protocol credentials 1454 on the right side, including MCP authentication token 1454a, A2A agent certificate 1454b, AgentSpace IAM identity assertion 1454c, and protocol-native scope representation 1454d. The outbound mapping (envelope→protocol) operates as follows: identity mapper 1450 extracts the agent's credential from the communication envelope, verifies it against the credential's native verification mechanism (DKIM signature verification, OAuth token introspection, or DID resolution), and translates the verified credential into the format expected by the selected agent-orchestration protocol. The inbound mapping (protocol→envelope) reverses this process: identity mapper 1450 receives the agent endpoint's protocol-native identity assertion, verifies it, and translates it back into the envelope's Agent Identifier format for inclusion in the refreshed envelope. This ensures that identity trust chains are preserved across the constraint boundary in both directions. The mappings between envelope credentials and protocol credentials are configurable and not limited to fixed pairings—any envelope credential type can be mapped to any protocol credential type through identity mapper 1450.

In one embodiment, the Agent Identifier in the communication envelope is cryptographically verifiable against at least one provenance mechanism: a DKIM/SPF/DMARC signature authenticating an organizational domain, an OAuth 2.0 client-credential access token, or a Decentralized Identifier (DID) or Verifiable Credential. Identity mapper 1450 translates this credential into the protocol-native format for the agent endpoint, and translates protocol-native identity assertions back into Agent Identifier form on the return path.

In one embodiment, the Agent Identifier further encodes a scope field specifying at least one principal—selected from natural persons, organizational entities, or government entities—on whose behalf the agent is authorized to act. The scope field is cryptographically bound to the provenance mechanism so that an agent cannot escalate its authorization beyond the delegated scope.

### Agent Identity Revocation

In one embodiment, bridge system 1400 includes an identifier-revocation service that monitors the validity of agent credentials across the protocol-constraint boundary. The revocation service polls authoritative revocation sources—such as certificate revocation lists for OAuth credentials, DKIM key rotation records for email domain credentials, and DID revocation registries for decentralized identifiers—and maintains a hot cache of revocation status. Prior to admitting any inbound communication envelope into the bridge's conversion pipeline, bridge system 1400—operating its own ingress envelope-routing function as a component of bridge system 1400—consults the revocation cache. If an agent's credentials have been revoked, the bridge rejects the envelope and records a revocation event in tamper-evident audit ledger 112, preventing compromised or deauthorized agents from continuing to operate through constrained surfaces. In a deployment integrated with the constraint-adaptive messaging system of the co-pending Application 1, the bridge's ingress envelope-routing function may be co-located with, or implemented by, the routing engine of that integrated system; in a standalone bridge deployment the function is performed by a routing component internal to bridge system 1400.

In one embodiment, the identifier-revocation service of paragraph [0069] maintains a hot-cache of revoked agent-identifier values indexed for sub-millisecond lookup. Bridge system 1400 verifies each inbound agent communication envelope against the hot-cache prior to admitting the envelope into the server-side security and compliance controls, such that revoked agents cannot reach the downstream pipeline stages. The hot-cache is refreshed on a configurable schedule (for example, every sixty seconds) from the authoritative revocation registry. Each agent-credential-revocation event is appended to tamper-evident audit ledger 112 with at least the revoked agent identifier, a revocation timestamp, a revocation reason indicator (for example, credential compromise, scope violation, administrative revocation, or time-based expiration), and a cryptographic signature over the revocation entry. Revocation events generated locally by bridge system 1400 (for example, upon detecting repeated scope violations by an agent) are propagated to other bridge instances operating under the same trust anchor, such that a revoked agent cannot circumvent the revocation by re-engaging through a different bridge instance. This revocation architecture is specifically designed for multi-agent multi-bridge deployments where agent identities are federated across bridges and across organizational boundaries.

In one embodiment, the hot-cache refresh schedule of paragraph [0070] is independently configurable per authoritative revocation registry, with each supported registry type maintained on its own refresh interval appropriate to the registry's cryptographic freshness guarantees and operational tempo. For example, bridge system 1400 may poll an X.509 Certificate Revocation List registry on a first configurable interval (corresponding to the “nextUpdate” field of the issued CRL); an Online Certificate Status Protocol responder on a second configurable interval with lazy demand-driven pull on identifier first-seen events; a DomainKeys Identified Mail domain-key rotation announcement registry on a third configurable interval bound to DNS TTL of the selector key record; a W3C Verifiable Credential Status List 2021 registry on a fourth configurable interval reflecting the issuer's status-list publication cadence; and an OAuth 2.0 RFC 7009 token revocation endpoint on a fifth configurable interval reflecting the authorization server's revocation-event publication cadence. Each polling operation emits a RevocationRegistryPoll record into tamper-evident audit ledger 112 with at least a registry-identifier field, the registry's responded-at timestamp, a registry-specific freshness indicator (for example, a CRL thisUpdate/nextUpdate pair or an OCSP thisUpdate timestamp), and a delta count of newly revoked identifiers. The independence of the refresh schedules permits the deployment to satisfy disparate freshness requirements—for example, a high-stakes banking deployment may poll OCSP on a five-second schedule while permitting a longer schedule on lower-stakes registries—without forcing a single monolithic polling interval across heterogeneous registries.

In one embodiment, the revocation reason indicator appended to each revocation-enforcement entry in tamper-evident audit ledger 112 is drawn from a strictly defined enumeration aligned with the IETF RFC 5280 Section 5.3.1 reason-code taxonomy—including at minimum keyCompromise, cACompromise, affiliationChanged, superseded, cessationOfOperation, certificateHold, privilegeWithdrawn, and their functional equivalents articulated as credentialCompromise, scopeViolation, administrativeSuspension, affiliationChange, supersededCredential, cessationOfOperation, credentialHold, privilegeWithdrawn, and timeBasedExpiration—such that downstream forensic systems can programmatically distinguish a routine time-based expiration (operational, not security-relevant) from a credential compromise (immediate investigation required) from a scope violation (agent-behavior anomaly) from an administrative suspension (policy-driven) without requiring natural-language parsing of a free-text reason field. The cryptographic signature applied to each revocation entry is executed as a discrete per-entry JSON Web Signature (JWS) authenticating the specific entry independently of the hash-chained ledger's head digest—that is, a signature that validates the entry's content against a signer's public key even when the auditor has access only to that single entry and its adjacent hash-chain linkage, without requiring the auditor to materialize the full ledger or its head. The per-entry JWS thereby provides per-entry auditor replayability: an auditor investigating a single revocation incident can verify the authenticity of the relevant ledger entry in isolation, and a compliance framework requiring evidence of specific revocation events (for example, HIPAA breach notification, GDPR Article 33 notification, or PCI DSS incident response) can produce the relevant entries with cryptographic proof without exposing the balance of the ledger.

### Cross-Boundary Hash Chain

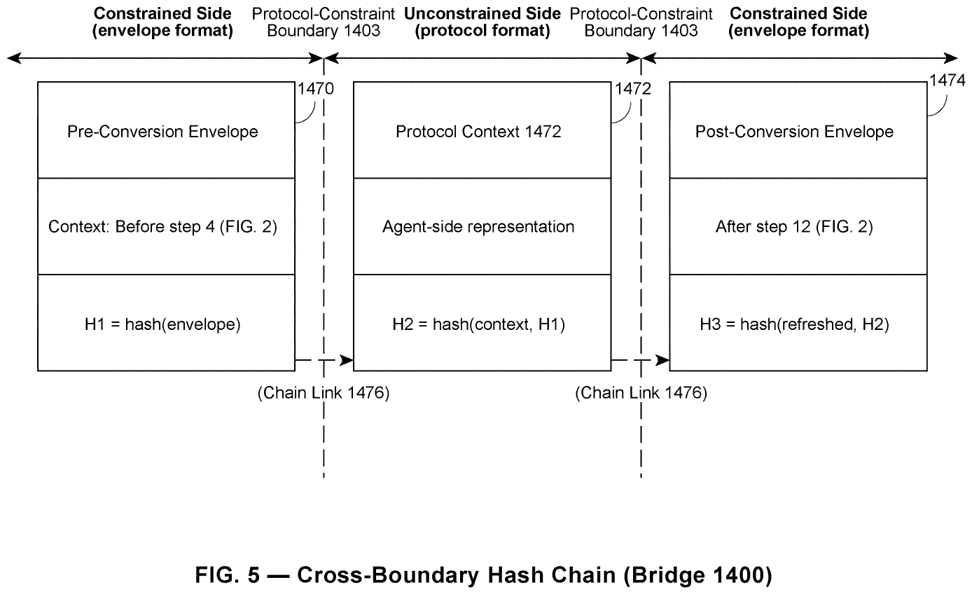

FIG. 5 is a diagram illustrating a cross-boundary hash chain maintained by bridge system 1400 across the protocol-constraint boundary, including pre-conversion record 1470 with hash H₁, protocol-context record 1472 with hash H₂, and post-conversion record 1474 with hash H₃, connected by hash chain links 1476. Referring to FIG. 5, bridge system 1400 maintains a cryptographic hash chain across the protocol-constraint boundary that records, at three architectural points, the integrity of every content transformation performed by the bridge. The hash chain includes three hash-linked records—pre-conversion record 1470, protocol-context record 1472, and post-conversion record 1474—connected by hash chain links 1476, each record corresponding to a distinct stage of the protocol-boundary crossing as described in the following paragraphs.

In one embodiment, the construction of the cross-boundary hash chain proceeds as follows. Pre-conversion record 1470 includes hash H₁, computed as “H₁=SHA-256(serialize(envelope_in))” over the serialized communication envelope received from the constrained message surface, before any protocol conversion. Protocol-context record 1472 includes hash H₂, computed as “H₂=SHA-256(H₁∥serialize(context_bundle_out))” over the concatenation of H₁ and the serialized context representation sent to agent-orchestration endpoint 1402; the explicit incorporation of H₁ into H₂'s pre-image creates the first hash chain link 1476 between record 1470 and record 1472, such that any post-hoc modification of the pre-conversion envelope produces a different H₂. Post-conversion record 1474 includes hash H₃, computed as “H₃=SHA-256(H₂ ∥serialize(envelope_out))” over the concatenation of H₂ and the serialized refreshed communication envelope produced after receiving and processing the agent's response; the explicit incorporation of H₂ into H₃'s pre-image creates the second hash chain link 1476 between record 1472 and record 1474, transitively binding H₃ to H₁. In an example embodiment, the hash function is SHA-256 producing 256-bit hashes; in other embodiments SHA-3, BLAKE3, or functionally equivalent hash functions may be used. Each of the three records (1470, 1472, 1474) is appended as a discrete entry in tamper-evident audit ledger 112, with the ledger's existing per-entry hash-chain mechanism providing a fourth chain link between the cross-boundary hash chain and the broader audit ledger.

In one embodiment, an auditor verifies the cross-boundary hash chain through the following procedure: at step (a), the auditor retrieves the archived serialized pre-conversion envelope from a secure archive and independently computes H₁′=SHA-256(serialize(envelope_in)); at step (b), the auditor compares H₁′ against the H₁ value recorded in pre-conversion record 1470 and confirms equality; at step (c), the auditor retrieves the archived serialized protocol context representation and independently computes H₂′=SHA-256(H₁∥serialize(context_bundle_out)) using the previously verified H₁; at step (d), the auditor compares H₂′ against the H₂ value recorded in protocol-context record 1472 and confirms equality; at step (e), the auditor retrieves the archived serialized post-conversion envelope and independently computes H₃′=SHA-256(H₂∥serialize(envelope_out)) using the previously verified H₂; at step (f), the auditor compares H₃′ against the H₃ value recorded in post-conversion record 1474 and confirms equality. The chain is valid if and only if all three equalities hold; failure of any equality indicates that the corresponding archived content was modified after the chain was established. The verification requires access only to the archived serialized representations and the recorded hashes—not to the plaintext content of the envelopes or to any session-key material—enabling compliance auditing of bridge operations without exposing sensitive conversational data to the auditor.

In one embodiment, the cross-boundary hash chain is architecturally distinct from conventional single-side hash chain mechanisms used in conventional secure-message or compliance-audit systems. A conventional single-side hash chain operates entirely within one zone (for example, an integrity log on the agent endpoint, or a transport-layer log on the message gateway) and provides no attestation that the content actually crossed the protocol boundary unmodified. By spanning the protocol-constraint boundary—with H₁ committed before protocol conversion, H₂ committed during protocol exchange, and H₃ committed after byte-budget enforcement and re-conversion—the cross-boundary hash chain provides a single auditable record of the integrity of every content transformation performed by the bridge: protocol conversion (verified by the H₁→H₂ link), byte-budget enforcement and re-conversion (verified by the H₂→H₃ link), and the unaltered passage of the envelope through any intermediate transports (verified by all three records being recoverable from the archive and producing matching hashes). Conventional single-side hash chains cannot provide this end-to-end attestation because they record content state only on one side of the boundary; a tampered protocol-conversion step would not be detectable from a single-side log. This cross-boundary hash chain is therefore a material element of the bridge's tamper-evident architecture and is appended to tamper-evident audit ledger 112 alongside the bridge's tool-invocation, fee-metering, and revocation events, providing a unified tamper-evident record of all bridge operations.

### Constrained Surfaces as Agent Communication Channels

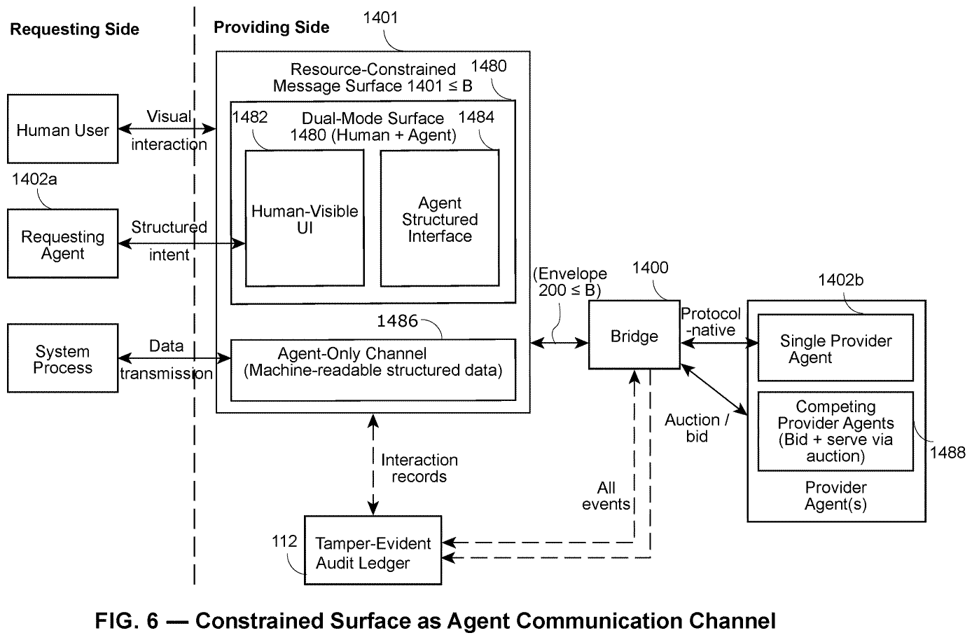

FIG. 6 is an architecture diagram illustrating a resource-constrained message surface 1401 functioning as a communication and transaction channel for autonomous software agents, showing dual-mode surface 1480, agent-only channel 1486, requesting agent 1402a, provider agent 1402b, and competing provider agents 1488. Referring to FIG. 6, in one embodiment, a resource-constrained message surface 1401 functions as a communication and transaction channel for autonomous software agents—either alongside a human-visible interface or as an agent-only data channel with no human-visible rendering. As shown in FIG. 6, the constrained surface supports three access modes. In dual-mode surface 1480, the surface provides both a human-visible UI 1482 (presenting visual content for human interaction) and a structured agent interface 1484 (exposing machine-readable structured data for programmatic agent interaction) simultaneously within the same byte-budget B—enabling a single constrained surface to serve both human and agent users concurrently. In agent-only channel 1486, the surface provides exclusively machine-readable structured data with no human-visible rendering—functioning as a constrained data-transmission channel between agents or between an agent and a system process.

Three requester types access the constrained surface: a human user interacts through the human-visible UI 1482 via visual browsing, form completion, and selection; a requesting agent 1402a interacts through the structured agent interface 1484 by transmitting a structured intent representation and receiving constraint-adapted results; and a system process interacts through the agent-only channel 1486 for machine-to-machine data exchange, automated monitoring, or programmatic transaction execution. On the providing side, bridge system 1400 connects the constrained surface to one or more provider agents—either a single provider agent 1402b for direct interaction, or competing provider agents 1488 that bid to serve the requester's query through the auction mechanism described in the co-pending Application 1 at paragraphs [0176], [0178], [0189], [0197], and [0199]. All interaction events, regardless of the access mode or requester type, are recorded in tamper-evident audit ledger 112.

This architecture enables constrained surfaces to serve as standardized communication endpoints for the emerging ecosystem of autonomous software agents. As agents increasingly perform browsing, commerce, research, negotiation, and service-provisioning tasks, the constrained surface—deployed within web pages, applications, devices, advertising slots, and any other hosting environment—provides a byte-budget-compliant, audit-recorded, security-controlled interface that agents can discover and interact with programmatically. The constrained surface is not limited to human-facing interaction; it serves equally as an agent-to-agent communication channel, a system-to-agent data interface, and a machine-to-machine transaction medium, with the constraint-adaptive architecture ensuring byte-budget compliance, identity verification, and auditability across all modes.

### Agent-Grade Interactivity Through Constrained Surfaces

The agent-orchestration bridge described herein enables autonomous software agents to conduct multi-turn interactions through message surfaces that were previously inaccessible to agent protocols—a capability that no prior system has achieved. As used herein, “multi-turn agent workflow” refers to an agent interaction including at least three sequential conversational turns through a constrained message surface, where the agent accumulates memory, invokes tools, and builds on prior-turn context across the turns. The three-turn threshold marks the architectural boundary at which the agent's reasoning on a given turn must depend on accumulated state established by prior turns—including the prior-turn agent memory, the prior-turn tool-invocation results, and the prior-turn capability-negotiation outcomes—rather than on the current turn's input alone. Once the agent's response on turn N is constrained by what was decided, retrieved, or transacted on turn N-1 or earlier, stateful session management across the protocol-constraint boundary becomes a structural requirement: each turn must reference accumulated tool state, accumulated negotiation state, and accumulated economic-settlement state that the constrained channel cannot itself preserve, which no prior bridge provides. The three-turn boundary is thus a measure of when accumulated cross-turn dependency manifests, not an admission about the architectural attainability of any particular smaller turn count under conventional patterns.

As used herein, “resolving the protocol-constraint boundary” refers to the coordinated operation of bridge components that simultaneously satisfy the agent protocol's requirements for large payloads, session persistence, tool invocation, and identity verification while conforming to the message surface's byte ceiling, sandbox restrictions, and absence of middleware. These constraints compound because agent protocols assume unconstrained channels—the payloads, runtimes, and round-trip patterns that agents depend on are precisely what constrained surfaces prohibit.

The bridge components recited in paragraph [0081] resolve each surface-imposed constraint through a specific bridge mechanism. The byte-ceiling constraint is resolved by byte-budget enforcer 1460 operating on agent-returned data through relevance-ranked subset selection with typed-placeholder substitution for excluded elements (per the algorithm of paragraph [0056]) and, where the surface additionally imposes a user-interface-element-count quota, by typed-placeholder consolidation per paragraph [0053]. The sandbox restriction—the surface's prohibition on executing the agent's protocol-native runtime client-side—is resolved by bidirectional conversion module 1410 forcing all agent-runtime computation onto the unconstrained-zone agent-orchestration endpoint 1402 and round-tripping only declarative, surface-compatible structural results back through the bridge, with executable elements deferred to the authenticated secure runtime channel of paragraph [0037]. The absent-middleware constraint—the surface's inability to host server-side identity, compliance, or settlement logic—is resolved by identity mapper 1450 (cross-boundary credential mapping per paragraph [0066]), the data-protection compliance profile injection of paragraph [0037], the cross-boundary hash chain of paragraphs [0073]-[0076], and fee meter 1440 (paragraphs [0061]-[0063]) all operating in the bridge zone rather than at the surface. The session-persistence constraint—the surface's inability to retain accumulated agent context across turns—is resolved by session store 1420 maintaining the canonical-action representation of paragraph [0083] across the protocol-constraint boundary, with multi-protocol fallback per paragraph [0102] preserving the same representation across protocol transitions. Each mechanism operates on the data crossing protocol-constraint boundary 1403 such that the agent protocol's operational requirements and the surface's restrictions are simultaneously satisfied without truncation, rejection, or workflow termination.

In one embodiment, the protocol-neutral intermediate representation into which session context is serialized for the multi-protocol fallback described in paragraphs [0101]-[0102] is produced by a canonical-action serializer that maps wire-format elements of a source agent-orchestration protocol to a canonical-action schema independent of any specific agent-orchestration protocol. The canonical-action schema includes at least: (i) a canonical action-identifier field that uniquely identifies a turn or action within the session; (ii) a canonical-tool-invocation-history field preserving an ordered sequence of per-turn tool invocations with, for each invocation, the tool name, arguments, result, and invocation timestamp; (iii) a canonical-memory field preserving the conversational memory—including at least the agent's prior-turn reasoning, running summaries, and retained user preferences—independently of the source protocol's specific memory-serialization format; and (iv) a canonical-settlement-record field preserving outstanding economic-settlement obligations—including at least the accumulated-fee value, the per-conversation cost-cap-remaining value, any pending fee-dispute indicator, and a reference to the latest FeeMeterEvent in tamper-evident audit ledger 112. Bridge system 1400 maintains a bidirectional protocol-to-canonical mapping table including, for each supported agent-orchestration protocol, a wire-to-canonical transformation used when the protocol is the predecessor in a fallback transition and a canonical-to-wire transformation used when the protocol is the successor. Representative mappings include, without limitation: (1) the Model Context Protocol JSON-RPC 2.0 tool-invocation structure (method, params, id, result) is bidirectionally mapped to the canonical-tool-invocation-history field such that method-to-tool-name, params-to-arguments, result-to-tool-result, and id-to-invocation-timestamp reference; (2) the Google Agent2Agent (A2A) Artifact structure (with artifactId, contextId, and parts) is bidirectionally mapped to the canonical-action-identifier field and the canonical-tool-invocation-history field; (3) a Google AgentSpace IAM identity assertion and associated session-context structure is bidirectionally mapped to the canonical-memory field; and (4) the native FeeMeterEvent schema of paragraph [0063] is referenced by digest into the canonical-settlement-record field. Because the canonical-action schema is protocol-neutral and covers all four elements of the session's continuing state (action identity, tool history, memory, settlement), the serializer ensures that a fallback from the predecessor protocol to the successor protocol occurs without information loss with respect to agent memory, tool-invocation history, or outstanding economic-settlement records, and the receiving protocol resumes interaction at the next turn without re-executing prior turns or reconstructing prior tool state. The canonical serialization operation is deterministic and produces a cryptographic digest that is embedded into the ProtocolFallback ledger event of paragraph [0102], providing verifiable auditable provenance of the state that crossed the protocol boundary.

In one embodiment, the canonical-action schema of paragraph [0083] is defined by a published JSON Schema document versioned concurrently with the supported agent-orchestration protocols, and the bidirectional protocol-to-canonical mapping table is maintained as a configuration artifact updatable independently of the bridge system's application logic, such that addition of support for a new agent-orchestration protocol requires only authoring the “wire↔canonical” mapping entry and does not require modification to the core bridge system. Supported mappings as of the present embodiment include the Model Context Protocol, the Google Agent2Agent (A2A) Protocol, the Google AgentSpace IAM session model, the OpenAI Agents SDK conversation model, the LangGraph checkpointer state model, the AutoGen conversable-agent state model, and any functionally equivalent agent-orchestration protocol. Where the source protocol or the destination protocol lacks a native concept corresponding to a canonical-action schema field, the mapping entry specifies an extension-field strategy wherein the canonical content is serialized into the protocol's extensibility channel (for example, an MCP “_meta” field, an A2A “metadata” object, or an AgentSpace custom-attribute mechanism) such that information preservation does not depend on the destination protocol natively exposing the field.

In addition to the message surfaces enumerated in paragraph [0034], the resource-constrained electronic message surface for purposes of this specification further includes, without limitation, machine-readable code presentations such as Quick Response (QR) codes, Data Matrix patterns, PDF417 barcodes, and Aztec codes. In an embodiment using a machine-readable code presentation as the surface, the surface operates in access-point mode: the code includes a conversation reference (for example, a URL, a conversation identifier, and a signed token) that, when decoded by a scanning device, triggers delivery of the communication envelope from the bridge system (or from Envelope Generator 101 of the co-pending Application 1) to the scanning device's display, subject to the same byte-budget, capability-negotiation, byte-budget-enforcement, and fee-metering architecture described herein. Multi-turn agent workflows initiated by a scan event of a machine-readable code are supported with the same architectural components used for message-transport-delivered surfaces.

In a representative procurement embodiment, an autonomous purchasing agent negotiates supplier terms via email over five turns: receiving a request-for-quote envelope (turn 1), querying supplier databases via tool invocation and returning comparison data (turn 2), presenting negotiation options (turn 3), executing a counter-offer based on user selection (turn 4), and confirming the final agreement with economic settlement (turn 5)—all within the AMP for Email byte-budget, with each agent response pruned by byte-budget enforcer 1460 to fit within B.

In a representative customer service embodiment, a support agent operates through push notifications over four turns: receiving an issue description (turn 1), running diagnostic tools and returning results (turn 2), presenting a resolution with cost estimate (turn 3), and executing the resolution with satisfaction confirmation (turn 4)—all within the 4,096-byte push notification constraint.

In a representative regulatory embodiment, a compliance agent assists with form completion via Adaptive Cards over three turns: presenting required fields based on regulatory jurisdiction (turn 1), validating submitted data against regulatory databases via tool invocation (turn 2), and confirming submission with audit trail (turn 3)—all within the 28,000-byte Adaptive Card constraint.

### Cross-Organizational Agent Communication

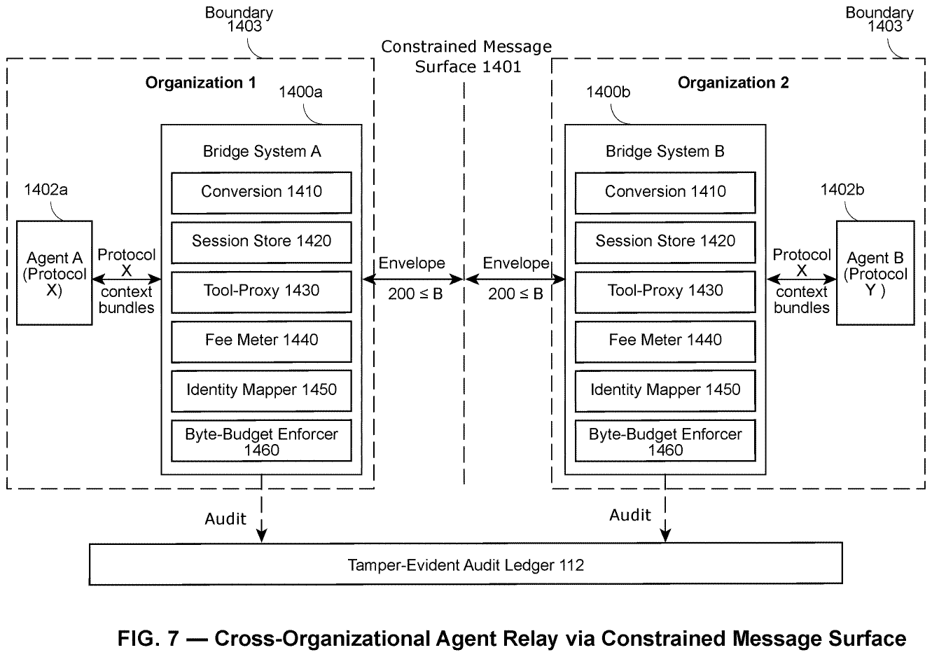

FIG. 7 is a block diagram illustrating cross-organizational agent relay via a resource-constrained message surface 1401, showing bridge system instance 1400a serving agent-orchestration endpoint 1402a and bridge system instance 1400b serving agent-orchestration endpoint 1402b. Referring to FIG. 7, in one embodiment bridge system 1400 enables autonomous software agents in separate organizations to communicate through constrained message surfaces without bilateral API integration. As shown in FIG. 7, a first organization (left) includes agent-orchestration endpoint 1402a (Agent A) operating through a first agent-orchestration protocol (e.g., MCP) connected to bridge system instance 1400a, and a second organization (right) includes agent-orchestration endpoint 1402b (Agent B) operating through a different agent-orchestration protocol (e.g., A2A) connected to bridge system instance 1400b. The constrained message surface 1401 (center)—such as email via SMTP—serves as the protocol-neutral intermediary between the two organizations. Each bridge instance includes the full set of bridge components (bidirectional conversion module 1410, session store 1420, tool-proxy module 1430, fee meter 1440, identity mapper 1450, and byte-budget enforcer 1460), enabling each side to independently convert between its agent's protocol and the constrained envelope format. Unconstrained context bundles flow bidirectionally between each agent and its bridge, while constraint-compliant envelopes (size not exceeding the channel byte-budget B and conforming to the surface's sandbox and middleware-absent constraints) flow through the constrained surface between bridges. Both bridge instances record interactions in a shared tamper-evident audit ledger 112. Because resource-constrained message surfaces such as email use universally routable addressing (SMTP), an agent operating on behalf of one organization can reach an agent operating on behalf of any other organization without requiring shared infrastructure, mutual API key exchange, or common protocol adoption. Bridge system 1400 converts the sending agent's protocol-native context into a constrained-channel envelope, transmits the envelope through the message surface, and—at the receiving end—converts the constrained-channel envelope back into the receiving agent's protocol-native format. This enables cross-organizational agent workflows through channels that every organization already operates, eliminating the bilateral integration overhead that currently limits agent-to-agent communication to organizations sharing a common protocol and infrastructure.

In one embodiment, two agents operating through different agent-orchestration protocols communicate through a constrained message surface via bridge system 1400. A first agent using Model Context Protocol generates a context bundle; bridge system 1400 converts the context bundle into a communication envelope constrained to channel byte-budget B, transmits the envelope through the message surface, and on the receiving side converts the envelope into a context representation compatible with a second agent using Google Agent2Agent (A2A) Protocol. Neither organization needs to implement the other's protocol. The constrained message surface serves as a protocol-neutral intermediary, and bridge system 1400 handles the bidirectional translation on each side.

In one embodiment, bridge system 1400 bridges between agent-orchestration protocols and legacy electronic data interchange formats—including but not limited to EDI X12, HL7v2, SWIFT MT, and FIX—by treating these legacy formats as resource-constrained message surfaces with their own byte ceilings, schema restrictions, and absent middleware. An agent operating through a modern orchestration protocol can interact with a legacy system through the same constraint-adaptive architecture, with bridge system 1400 enforcing the legacy format's constraints on the agent's output and converting between the agent's protocol-native representation and the legacy schema.

In a representative HL7v2 embodiment, an autonomous clinical-decision-support agent operating through MCP coordinates a multi-turn medication-reconciliation workflow with a legacy hospital information system that exclusively accepts HL7v2 messages over a Minimal Lower Layer Protocol (MLLP) transport. Bridge system 1400 (i) treats the HL7v2 ADT\hat{ }A04/ADT\hat{ }A08/RDE\hat{ }O11 message types as the legacy “resource-constrained message surface” with their pipe-and-hat segment delimiters and per-segment field constraints functioning as the schema-restriction analogue of channel byte-budget B; (ii) maps the agent's MCP context bundle into the HL7v2 segment-level grammar through bidirectional conversion module 1410—for example, mapping the agent's structured medication-reconciliation intent into RXE/RXR/RXC segments of an RDE\hat{ }O11 order message and the agent's prior-turn tool-invocation results into ZxxN custom-segment carriers cryptographically bound to the canonical-action schema of paragraph [0083]; (iii) applies the data-protection compliance profile (HIPAA) of paragraph [0037] before any envelope traverses the legacy MLLP transport, with PHI elements substituted by typed placeholder assets whose authenticated retrieval references resolve only through the secure runtime channel; (iv) records each HL7v2 ACK/NAK acknowledgment, each placeholder-hydration event, and each FeeMeterEvent in tamper-evident audit ledger 112 keyed by the legacy message-control identifier (MSH-10) joined to the canonical action-identifier; and (v) preserves session continuity across multiple HL7v2 message exchanges through session store 1420 keyed by Patient Identifier (PID-3) so that subsequent ADT or order messages on the same patient build on the agent's accumulated context. The same architectural pattern applies to EDI X12 (where Interchange Control Number ISA-13 plays the analogous identifier role), SWIFT MT (where Message Reference MT-20 plays that role), and FIX (where SenderCompID/ClOrdID combinations play that role); in each case, the bridge enforces the legacy format's per-segment-or-field constraints, applies the appropriate data-protection compliance profile, and preserves session state across the legacy message exchange.

### Structured Intent Through The Bridge

In one embodiment, an autonomous software agent transmits a structured intent representation through bridge system 1400 to a constrained message surface. The structured intent includes at least a description of the desired outcome (such as a product or service need, an information query, a task to be completed, or a negotiation objective), constraints on acceptable terms (such as budget limits, delivery requirements, regulatory compliance mandates, or quality thresholds), and context from the agent's accumulated session state. Bridge system 1400 converts the structured intent from the agent's protocol-native representation into a query compatible with the constrained surface's offerings—for example, converting an MCP context bundle describing a procurement need into a byte-budget-compliant query against a supplier's embedded agentic surface, or converting an A2A task description into an Adaptive Card form that a human approver can evaluate and act upon. The constrained surface responds with relevance-ranked results adapted to its byte-budget, and the agent can evaluate, interact with, and act upon the results across multiple turns.

In an illustrative procurement example, an autonomous purchasing agent operating on behalf of a manufacturing organization transmits a structured intent representation through bridge system 1400 to embedded agentic surfaces operated by three competing suppliers. The structured intent representation in the agent's protocol-native MCP format includes (a) a desired-outcome field including “product_category=‘industrial fasteners−Grade 8 hex bolts, ½-inch, fully threaded’”; (b) a constraints field including “budget_ceiling=5000 USD, delivery_window=14_days, regulatory=ITAR_cleared, quantity=2000_units”; and (c) a context-metadata field including the requesting organization's identifier, the agent's prior-turn negotiation history with the same suppliers (retrieved from session store 1420), and the organization's preferred payment terms. Bridge system 1400 converts the MCP context bundle into a byte-budget-compliant request-for-quote envelope (size less than or equal to B=102,400 bytes for AMP for Email), dispatches the envelope to each supplier's embedded surface, and over five turns conducts the negotiation as set forth in paragraph [0086]: receiving the request-for-quote (turn 1), querying supplier databases via tool invocation and returning per-supplier comparison data with byte-budget enforcement applied to each supplier's quote payload (turn 2), presenting negotiation options reflecting the budget and delivery constraints (turn 3), executing a counter-offer based on user selection (turn 4), and confirming the final-selection commitment with FeeMeterEvent settlement recorded in tamper-evident audit ledger 112 (turn 5). Each turn's structured-intent payload remains byte-budget-compliant through byte-budget enforcer 1460 while the agent's accumulated context, preference history, and capability-negotiation state persist across the five turns through session store 1420. This example illustrates that the structured-intent mechanism enables autonomous agents to conduct genuine multi-party negotiation through resource-constrained channels-a capability that conventional stateless protocol adapters cannot provide because they cannot persist negotiation history across turns.

### Agent Reputation Derived From Audit Ledger

In one embodiment, tamper-evident audit ledger 112 serves as the authoritative source for agent reputation data. Because every interaction event—tool invocation, response delivery, transaction completion, settlement, and user or agent satisfaction signal—is recorded as a hash-linked record in the ledger, the system can derive verifiable reputation scores for each participating agent. The reputation score is constructed from three principal components—historical completion rate, response quality, and settlement reliability—each defined and measured as described in the following paragraphs. Because the reputation data is derived from cryptographically linked audit records rather than self-reported ratings, it is resistant to manipulation. In one embodiment, the reputation score influences the agent's priority for constrained-surface placement, tool-invocation authorization, and the terms offered by counterparty agents during negotiation.

In one embodiment, the historical completion rate component is defined as the fraction of agent workflows initiated by the agent that reach successful settlement, computed over a configurable observation window (for example, the most recent 10,000 workflows or the most recent 90 days, whichever is greater). Bridge system 1400 derives the completion rate from tamper-evident audit ledger 112 by counting (i) the number of workflow-initiation events recorded for the agent (each such event being a SessionStart entry in the ledger including at least the conversation identifier, the agent identifier, and an initiation timestamp) and (ii) the number of settlement-commit events recorded for the same conversation identifiers (each such event being a FeeMeterEvent with a settlement-status indicator equal to “committed”). The completion rate equals (settlement-commit count/workflow-initiation count). Workflow-initiation events without a corresponding settlement-commit event within the observation window—whether due to recipient abandonment, agent failure, or capability-negotiation breakdown—reduce the completion rate.

In one embodiment, the response quality component is defined as a per-turn measure of whether the receiving party continued the interaction or abandoned it after observing the agent's response. Bridge system 1400 derives the response quality signal from tamper-evident audit ledger 112 by examining, for each agent-response delivery event recorded in the ledger, whether the next-turn-from-recipient event occurred within a configurable response-window (for example, 24 hours) on the same conversation identifier. A continuation signal is positive when a recipient interaction is recorded within the response-window; a continuation signal is negative when no further recipient interaction occurs within the response-window or when the recipient explicitly cancels the workflow. The response-quality component is computed as a moving average of the continuation signal across the most recent N agent-response delivery events (for example, N=1,000), expressed as a value in the closed interval [0, 1].

In one embodiment, the settlement reliability component is defined as a composite measure of (i) the agent's pre-invocation refusal rate—the fraction of capability-negotiation attempts in which the agent's tool offerings were rejected by counterparties due to agent-specific terms—derived from CapabilityNegotiation entries in tamper-evident audit ledger 112; (ii) the agent's post-settlement dispute rate—the fraction of FeeMeterEvent entries that subsequently received a DisputeRaised entry in the ledger within a configurable dispute-window—derived from cross-referencing FeeMeterEvent entries against DisputeRaised entries; and (iii) the agent's on-time settlement rate—the fraction of FeeMeterEvent entries committed within a configured settlement-latency target relative to the workflow-completion event. The settlement reliability component is the weighted combination of these three sub-measures, each normalized into the closed interval [0, 1] (with refusal and dispute inverted such that low rates produce high sub-scores).

In one embodiment, the three principal components are combined into a single reputation score using the formula “score=w_c·completion_rate+w_q·response_quality+w_s·settlement_reliability”, where w_c, w_q, and w_s are operator-tunable coefficients that satisfy w_c+w_q+w_s=1. In an example embodiment, w_c=0.4, w_q=0.3, and w_s=0.3, with the operator able to adjust the coefficients to reflect the deployment's emphasis on completion volume versus interaction quality versus settlement integrity. The combined reputation score is updated incrementally as new ledger entries accumulate—each SessionStart, FeeMeterEvent, recipient-continuation, or DisputeRaised event triggers a recomputation of the relevant component. ReputationUpdate entries themselves are explicitly excluded from the recomputation-trigger event set so as not to cause recursive recomputation, and the recomputation pipeline filters incoming ledger events against the trigger-event allowlist so that only the four primary event categories enumerated above can initiate a reputation recomputation. The reputation score is itself appended to the ledger as a ReputationUpdate entry including at least the agent identifier, the predecessor score, the successor score, the contributing events, and a recomputation timestamp, providing a tamper-evident history of every reputation change for forensic and dispute-resolution purposes.

### Bridge as Interaction Mediator

In one embodiment, bridge system 1400 functions not only as a protocol translator but as a multi-capability interaction mediator that coordinates intent routing, multi-party communication, reputation evaluation, and economic settlement across the protocol-constraint boundary. When an agent interaction involves multiple constrained surfaces—for example, a buying agent querying embedded surfaces on multiple web pages simultaneously, or a service agent coordinating between a customer surface (email) and an internal system surface (Adaptive Card)—bridge system 1400 maintains independent session state for each surface, routes the agent's intent to each surface in parallel, aggregates responses, and presents a unified result to the agent constrained to the byte-budget of the agent's own reporting surface. This enables complex multi-surface agent workflows—such as comparative shopping across multiple vendors, coordinated multi-party approvals, or distributed data collection across organizational boundaries—all mediated through the constraint-adaptive architecture with every interaction recorded in the audit ledger.

### Multi-Protocol Fallback

In one embodiment, when capability negotiation with a primary agent-orchestration protocol fails—for example, when the agent endpoint does not respond within a configurable timeout, returns an incompatible capability set, or rejects the connection—bridge system 1400 automatically renegotiates using a next-priority protocol from an ordered fallback list. The fallback list is a ranked sequence of agent-orchestration protocols (for example, MCP as primary, A2A as secondary, AgentSpace as tertiary) configured per conversation or per agent endpoint. Bridge system 1400 attempts capability negotiation with each protocol in rank order until negotiation succeeds or the list is exhausted; if the list is exhausted, bridge system 1400 records a negotiation-failure event in tamper-evident audit ledger 112 and returns a failure envelope to host-channel client 120. When fallback to a secondary protocol succeeds, session store 1420 preserves the accumulated session context from prior turns—the agent's memory, tool invocation history, and negotiation state are not lost due to the protocol switch. Bidirectional conversion module 1410 applies the schema-translation mapping for the newly selected protocol, and all subsequent turns proceed through the fallback protocol until the conversation ends or the primary protocol becomes available again. Critically, byte-budget enforcer 1460 applies the channel byte-budget B identically regardless of which protocol is ultimately selected, ensuring that the channel constraints are respected irrespective of the agent protocol in use—the fallback affects only the unconstrained-side protocol format, not the constrained-side envelope compliance.

The session-state preservation across the protocol-fallback transition of paragraph [0101] is a material property of the fallback mechanism. Session store 1420 retains accumulated session context including at least (i) agent memory—the consolidated context representations, memory patches, and conversational history accumulated across prior turns; (ii) tool-invocation history—the record of each tool invoked by the agent, including tool identifier, invocation parameters, tool response, and tool-hash/policy-hash propagation state; and (iii) outstanding economic-settlement records—any pending fee-metering computations that have not yet been committed to the audit ledger. Upon protocol fallback, session store 1420 serializes the accumulated session context into a protocol-neutral representation suitable for re-serialization into the successor protocol's native context schema by bidirectional conversion module 1410. The serialization-and-re-serialization path preserves the semantic content of the session context across the protocol boundary without requiring the agent to re-execute prior turns or reconstruct prior tool-invocation state. Each protocol-fallback transition is appended to tamper-evident audit ledger 112 as a ProtocolFallback event including at least a predecessor-protocol identifier, a successor-protocol identifier, the triggering fallback criterion (for example, primary-protocol timeout, incompatible capability set, connection rejection), and a transition timestamp. The protocol-fallback capability is architecturally significant because it decouples agent workflow continuity from the availability of any single agent-orchestration protocol—if the primary protocol becomes unavailable mid-conversation, the agent resumes through the successor protocol without loss of accumulated context.

### Multi-Peer Relay and Cross-Protocol Communication

In one embodiment, bridge system 1400 relays communication envelopes among interaction peers including autonomous software agents, human-operated clients, and mixed-initiative processes. Each relay includes a direction indicator designating the interaction mode: agent-to-agent (both endpoints are autonomous software agents), agent-to-human (the agent's response is rendered for a human recipient), human-to-agent (a human's input is converted into the agent's protocol-native format), or agent-to-system (the agent interacts with a non-agent system endpoint such as a database, API, or legacy EDI processor). The direction indicator determines how bridge system 1400 formats the relayed envelope—for example, an agent-to-human relay formats the agent's response for human-readable presentation within the constrained surface, while an agent-to-agent relay preserves machine-readable context structure. Each relay event is recorded in tamper-evident audit ledger 112 with an exchange hash covering the peer identifiers, direction indicator, and payload digest, creating a verifiable record of every relay hop. When a conversation involves multiple peers—for example, a buying agent communicating with three selling agents simultaneously—bridge system 1400 maintains independent session state in session store 1420 for each peer interaction, routes the buying agent's intent to each selling agent through the constrained surface, and aggregates responses for comparison, all within the channel byte-budget B.

Multi-peer session management is implemented by session store 1420 maintaining a separately keyed session record per peer-pair within an aggregating parent session. In one embodiment, the parent session is keyed by an aggregating-conversation identifier (for example, the buying agent's request-for-quote identifier) and indexes a plurality of child session records, each child session keyed by the aggregating-conversation identifier concatenated with the counterpart-peer identifier. Each child session record independently preserves the four canonical-action-schema fields (action-identifier, tool-invocation-history, memory, settlement-record) of paragraph [0083] for its respective peer-pair, such that capability negotiations, tool-invocation sequences, and accumulated economic-settlement obligations against one selling agent do not contaminate the equivalent state for any other selling agent. Bridge system 1400 dispatches an outbound envelope per child session in parallel, awaits per-child responses subject to a configurable per-child response-window, and applies byte-budget enforcer 1460 independently to each per-child response so that individual responses remain budget-compliant even when the cumulative aggregated response would exceed channel byte-budget B. The parent session's aggregator subsystem then composes a comparison response for the requesting agent—for example, a typed summary placeholder asset whose authenticated retrieval reference resolves to the selected child session's complete content through the secure runtime channel—within the requesting agent's own channel byte-budget. Each per-child interaction event, each parallel-dispatch event, and each aggregation event is recorded in tamper-evident audit ledger 112 as a discrete entry with cross-reference to the parent aggregating-conversation identifier, providing per-pair auditability without conflating peer-specific events.

In one embodiment, as illustrated in FIG. 7, both interaction peers at the endpoints of a relay are autonomous software agents operating through different agent-orchestration protocols—for example, agent-orchestration endpoint 1402a operating through Model Context Protocol and agent-orchestration endpoint 1402b operating through Google Agent2Agent (A2A) Protocol. Bridge system 1400 resolves the protocol-constraint boundary on both sides of the relay: bridge instance 1400a converts Agent A's MCP context into a constraint-compliant envelope (subject to the channel byte-budget and other surface-imposed constraints) for transmission through the constrained message surface, and bridge instance 1400b converts the received envelope into A2A format for Agent B. On the return path, bridge instance 1400b converts Agent B's A2A response into a constrained envelope, and bridge instance 1400a converts it back into MCP format for Agent A. Neither agent needs to implement the other's protocol, and neither organization needs to establish bilateral API integration—the constrained message surface (such as email via SMTP) serves as the universally routable, protocol-neutral intermediary, and each bridge instance handles conversion independently. This cross-protocol relay capability enables autonomous agents across organizational boundaries to conduct multi-turn workflows—including procurement negotiations, supply-chain coordination, regulatory filings, and dispute resolution—through channels that every organization already operates, with byte-budget enforcement, identity verification, and audit-ledger recording applied at every protocol-constraint boundary crossing.

The specific formulas, algorithms, coefficient values, cryptographic primitives, and parameter values recited throughout this specification are illustrative preferred embodiments and do not limit the scope of any claim or any disclosed mechanism. Any function, rule set, model, cryptographic primitive, or successor technique that performs the corresponding computational role falls within the scope of the disclosed mechanism, regardless of whether it employs different coefficients, weighting schemes, hash or signature algorithms, parameter values, or computational approach. The system is not limited to any particular computational expression recited herein.

What is claimed is:

1. A computer-implemented system comprising one or more processors and a memory storing instructions, the instructions, when executed by the one or more processors, causing the system to apply server-side security and compliance controls to communication envelopes processed by the system and to:
(a) for a resource-constrained electronic message surface that delivers a communication envelope subject to at least a byte-ceiling constraint defining a channel byte-budget, resolve a protocol-constraint boundary between the message surface and an agent-orchestration protocol whose payloads exceed the byte ceiling;
(b) maintain stateful session context across the protocol-constraint boundary such that agent memory, tool invocation history, and negotiation state persist across a plurality of conversational turns through the message surface;
(c) enforce the channel byte-budget on data returned from the agent-orchestration protocol by selecting a subset of returned elements based on relevance while retaining references to excluded elements, ensuring that agent responses that exceed the byte ceiling are delivered without truncation or rejection;
(d) record each tool invocation, economic settlement event, and content transformation in a tamper-evident audit ledger; and
(e) enable an autonomous software agent to conduct a multi-turn agent workflow-comprising at least three sequential conversational turns with a stateful session context persisting across the turns through the resource-constrained message surface, the autonomous software agent operating through a channel that was previously inaccessible to agent protocols.

2. The system of claim 1, further comprising an economic settlement component configured to (i) calculate a usage fee or a success fee associated with each tool invocation or agent turn conducted through the resource-constrained electronic message surface, the calculation being performed independently of the particular agent-orchestration protocol employed; and (ii) append each calculated fee to the tamper-evident audit ledger as a FeeMeterEvent including at least a turn identifier, the calculated fee value, and a timestamp, such that the accumulated fee data is available for reconciliation across the plurality of conversational turns of the multi-turn agent workflow.

3. The system of claim 2, wherein the economic settlement component is further configured to cryptographically bind each fee computation to the tamper-evident audit ledger by appending the FeeMeterEvent to the ledger as an integral step of the fee computation such that the fee value is not finalized until the FeeMeterEvent is hash-linked to a preceding ledger record, providing tamper-evident accountability for each per-turn fee such that no fee computation exists outside the hash-linked ledger record, enabling agent marketplace economics within byte-constrained message surfaces.

4. The system of claim 1, wherein the system maintains a cryptographic hash chain across the protocol-constraint boundary by computing a hash of the communication envelope prior to conversion, linking that hash to a hash of a context representation sent to the agent-orchestration protocol, and linking to a hash of a refreshed communication envelope produced after processing the agent's response, enabling an auditor to verify the integrity of every content transformation without access to plaintext.

5. The system of claim 1, wherein when capability negotiation with a primary agent-orchestration protocol fails, the system automatically renegotiates using a next-priority protocol from a fallback list, byte-budget enforcement being applied identically regardless of which protocol is selected.

6. The system of claim 1, wherein the system relays one or more communication envelopes among interaction peers comprising autonomous software agents, human-operated clients, and mixed-initiative processes, each relay including a direction indicator designating the interaction mode, and wherein each relay event is recorded in the tamper-evident audit ledger.

7. The system of claim 1, further comprising an agent-credential revocation monitor that maintains a hot-cache of revoked agent-identifier values and verifies each inbound agent communication envelope against the hot-cache prior to admitting the envelope into the server-side security and compliance controls, the hot-cache being refreshed on a configurable schedule from an authoritative revocation registry, and wherein each agent-credential-revocation event is appended to the tamper-evident audit ledger as a revocation entry comprising at least the revoked agent identifier, a revocation timestamp, a revocation reason indicator selected from a revocation-reason enumeration comprising at least credential compromise, scope violation, administrative revocation, and time-based expiration, and a cryptographic signature over the revocation entry.

8. The system of claim 2, wherein the economic settlement component is configured as a micropayment fee meter that calculates per-turn usage fees according to a formula combining a token-count component, an application-programming-interface-call-count component, and a compute-time component, each component multiplied by a configurable per-unit rate, and enforces a per-turn cost cap configurable to a value below one cent, the fee meter supporting sub-cent precision in both rate configuration and accumulated-fee reporting, and wherein the FeeMeterEvent further comprises a turn identifier, a computed per-turn cost value at sub-cent precision, a cumulative-cost value, and a cost-cap-remaining value.

9. The system of claim 5, wherein stateful session context comprising at least agent memory, tool-invocation history, and outstanding economic-settlement records—each outstanding economic-settlement record comprising at least an accumulated-fee value, a per-conversation cost-cap-remaining value, a fee-dispute indicator, and a reference to a most-recent fee-metering event in the tamper-evident audit ledger—is preserved across the protocol transition through serialization of the session context into a protocol-neutral intermediate representation and re-serialization into the successor protocol's native context schema by a bidirectional conversion module, such that the autonomous software agent resumes interaction through the next-priority protocol without re-executing prior turns or reconstructing prior tool-invocation state and without loss of any pending economic-settlement obligation accrued under the predecessor protocol, and wherein each such protocol transition is appended to the tamper-evident audit ledger as a ProtocolFallback event comprising at least a predecessor-protocol identifier, a successor-protocol identifier, a triggering fallback criterion, a transition timestamp, and a digest of the outstanding-economic-settlement-record carried across the transition.

10. The system of claim 2, wherein the economic settlement component enforces a per-conversation cost cap configurable to a value below one United States dollar, evaluates a composite turn-cost prior to executing an agent turn or tool invocation based on a formula combining at least two variables selected from a token-count variable, an application-programming-interface-call-count variable, and a compute-time variable, and refuses the invocation when the evaluated turn-cost would cause an accumulated fee for the conversation to exceed the per-conversation cost cap, the refusal decision being recorded in the tamper-evident audit ledger as a FeeMeterEvent comprising a refusal indicator and the evaluated turn-cost value, such that the pre-invocation refusal decision is itself cryptographically bound to the hash-linked ledger record and such that computational resources are protected against runaway accumulation resulting from recursive agent invocations or logic loops that would otherwise exceed the cost cap without pre-invocation enforcement.

11. The system of claim 1, wherein each communication envelope delivered through the message surface contains an Agent Identifier that is cryptographically verifiable against at least one provenance mechanism, and wherein the system bidirectionally maps the Agent Identifier between the envelope's native credential format and a protocol-native identity representation, such that identity trust chains are preserved across the protocol-constraint boundary.

12. The system of claim 11, wherein the Agent Identifier further encodes a scope field specifying at least one principal on whose behalf the autonomous software agent is authorized to act, the scope field being cryptographically bound to the at least one provenance mechanism so that the autonomous software agent cannot escalate its authorization beyond the delegated scope.

13. The system of claim 1, wherein data returned from the agent-orchestration protocol that contains sensitive information—including, without limitation, protected health information, personally identifiable information, financial data, trade secrets, or any data subject to a regulatory protection mandate—is transmitted to the resource-constrained message surface exclusively through an authenticated secure channel established when a host-channel client renders the communication envelope, and wherein an initial communication envelope transmitted via a standard message delivery transport contains only typed placeholder assets representing the sensitive data elements, the sensitive data never traversing the standard message delivery transport, such that the system enforces a two-phase delivery security model in which agent-mediated sensitive data flows exclusively through the authenticated secure channel after recipient authentication satisfying a data-protection compliance profile applicable to the agent-mediated data.

14. The system of claim 1, wherein the resource-constrained electronic message surface comprises a legacy electronic data interchange format having rigid schema constraints, and wherein the system bridges between the agent-orchestration protocol and the legacy format by treating the legacy format's schema restrictions and payload limits as the byte-ceiling constraint to be resolved.

15. The system of claim 1, wherein the autonomous software agent transmits a structured intent representation through the system, the structured intent comprising at least a description of a desired outcome and constraints on acceptable terms, and wherein the system converts the structured intent into a query compatible with offerings available through the resource-constrained message surface, receives relevance-ranked results adapted to the channel byte-budget, and presents the results to the autonomous software agent for evaluation and action across multiple interaction turns.

16. The system of claim 1, wherein the tamper-evident audit ledger serves as an authoritative source for agent reputation data, and wherein computing the reputation data comprises (i) enumerating hash-chained audit ledger entries associated with the autonomous software agent, the enumerated entries comprising at least interaction completion records, response quality records, and fulfillment timeliness records; (ii) verifying, for each enumerated entry, that the entry's cryptographic hash linkage to its predecessor entry is valid; (iii) rejecting any enumerated entry whose hash linkage fails verification prior to including the entry in the reputation computation; and (iv) computing the reputation data from the subset of enumerated entries whose hash linkages verified, such that the reputation data is cryptographically bound to the unforgeable audit-chain structure rather than to self-reported ratings.

17. The system of claim 1, wherein the resource-constrained message surface comprises a machine-readable code presentation including a Quick Response (QR) code, a Data Matrix pattern, a PDF417 barcode, or an Aztec code, and the multi-turn agent workflow is initiated by a scan event in which a scanning device decodes the machine-readable code, the scan event triggering capability negotiation with the agent-orchestration protocol and causing the system to enforce the channel byte-budget on data returned from the agent-orchestration protocol to a display of the scanning device, such that the agent-orchestration protocol bridges to a byte-constrained surface that was previously inaccessible to agent protocols.

18. The system of claim 6, wherein both interaction peers at the endpoints of a relay are autonomous software agents operating through different agent-orchestration protocols, and wherein the system resolves the protocol-constraint boundary on both sides of the relay, enabling cross-protocol agent-to-agent communication through the resource-constrained message surface without bilateral application-programming-interface integration between organizations operating the respective autonomous software agents.

19. A computer-implemented method performed by one or more processors, the method comprising:
(a) for a resource-constrained electronic message surface that imposes at least a byte-ceiling constraint defining a channel byte-budget, resolving a protocol-constraint boundary between the message surface and an agent-orchestration protocol whose payloads exceed the byte ceiling;
(b) maintaining stateful session context across the protocol-constraint boundary such that agent memory and tool invocation history persist across a plurality of conversational turns;
(c) enforcing the channel byte-budget on data returned from the agent-orchestration protocol by selecting a subset based on relevance while retaining references to excluded elements;
(d) recording each tool invocation and economic settlement event in a tamper-evident audit ledger; and
(e) enabling an autonomous software agent to conduct a multi-turn agent workflow through the resource-constrained message surface.

20. The method of claim 19, further comprising bidirectionally mapping agent identity credentials between a native credential format of a communication envelope delivered through the message surface and a protocol-native representation, preserving trust chains across the protocol-constraint boundary.

21. A non-transitory computer-readable medium storing instructions that, when executed by one or more processors, cause the processors to perform the method of claim 19.

22. A computer-implemented system for cross-organizational autonomous-agent communication, comprising:
(a) a first agent-orchestration bridge instance, deployed in a first organization, comprising one or more processors and a memory storing instructions causing the first bridge instance to bidirectionally convert between context bundles in a first agent-orchestration protocol native to a first autonomous software agent and constraint-compliant communication envelopes sized to fit within a channel byte-budget of a resource-constrained electronic message surface;
(b) a second agent-orchestration bridge instance, deployed in a second organization separate from the first organization, comprising one or more processors and a memory storing instructions causing the second bridge instance to bidirectionally convert between context bundles in a second agent-orchestration protocol native to a second autonomous software agent and the constraint-compliant communication envelopes, the second agent-orchestration protocol differing from the first agent-orchestration protocol;
(c) wherein the resource-constrained electronic message surface, having universally routable addressing, serves as the protocol-neutral intermediary between the first bridge instance and the second bridge instance, conveying the constraint-compliant communication envelopes between the two bridge instances without bilateral application-programming-interface integration between the first organization and the second organization;
(d) wherein each of the first bridge instance and the second bridge instance preserves stateful session context across the protocol-constraint boundary such that agent memory, tool invocation history, and negotiation state persist across a plurality of conversational turns; and
(e) wherein each cross-organizational interaction event—including at least envelope transmission, envelope receipt, and per-turn economic settlement—is recorded in a tamper-evident audit ledger accessible to the first bridge instance and the second bridge instance,
such that the first autonomous software agent and the second autonomous software agent conduct a multi-turn cross-organizational agent workflow through the resource-constrained electronic message surface without bilateral application-programming-interface integration between their respective organizations and without either organization implementing the other's agent-orchestration protocol.
